(19) United States
(12) Patent Application Publication
(10) Pub. No.: US 2026/0000494 A1
(43) Pub. Date: Jan. 1, 2026

(54) TRY-IN DENTURE BASE

(71) Applicant: EXOCAD GMBH, Darmstadt (DE)

(72) Inventor: Gustavo Ismael, Sao Paulo (BR)

(21) Appl. No.: 18/754,471

(22) Filed: Jun. 26, 2024

(51) Int. Cl. A61C 13/01; A61C 13/00

(52) U.S. Cl. CPC A61C 13/04; A61C 13/0004

(57) ABSTRACT

The invention relates to a try-in denture base comprising one or more receptions for receiving basal sections of artificial teeth. A first reception is configured to receive two or more basal sections of two or more artificial teeth. A reception volume provided by the first reception is larger than a combination of basal volumes of the two or more basal sections of the two or more artificial teeth to be received. The first reception forms a continuous open space configured to enable a relative movement of the two or more basal sections of the two or more artificial teeth within the first reception towards and away from each other.

### FIELD OF THE INVENTION

The invention relates to the field of dental technology, in particular to a try-in denture base.

### BACKGROUND

When designing a full or partial denture, usually a plurality of try-ins in form of denture models made from wax, also referred to as wax-ups, may subsequently be manufactured and tested, in order to determine a final form for the denture that properly fits a patient's anatomy. In general, it may be expected that a wax-up does not perfectly fits patient's anatomy. The wax-up may tested with the patient and adjusted to the patient's anatomy. The adjusted wax-up may then be used as a template for the next revised wax-up, which is again tested. This procedure may be repeated, until a wax-up is provided, which properly fits the patient's anatomy and may be used as a template for the actual denture.

Such wax-ups may be easily adjustable, but they may have problems, e.g., with an overall stability of their form, in particular when an environmental temperature may be rather high, e.g., in summer. Furthermore, the easy adjustability may have the drawback that accidental amendments during try-in and/or adjusting of the wax-up may occur. Such accidental amendments may require additional adjustment cycles.

### SUMMARY

It is an objective to provide for a try-in denture base, a computer program product comprising manufacturing data defining a three-dimensional digital base model of the try-in denture base as a template for manufacturing the try-in denture base, and a computer device comprising a memory further storing manufacturing data defining a three-dimensional digital base model of a try-in denture base as a template for manufacturing the try-in denture base.

In one aspect, the invention relates to a try-in denture base comprising one or more receptions for receiving basal sections of artificial teeth of a plurality of artificial teeth. A first reception of the one or more receptions is configured to receive two or more basal sections of two or more artificial teeth of the plurality of artificial teeth. A reception volume provided by the first reception is larger than a combination of basal volumes of the two or more basal sections of the two or more artificial teeth to be received by the first reception. The first reception forms a continuous open space configured to enable a relative movement of the two or more basal sections of the two or more artificial teeth within the first reception towards and away from each other.

Examples may have the beneficial effect, that a base for an adjustable try-in denture is provided. The continuous open space provided by the first reception enables a relative movement of the two or more artificial teeth within the first reception towards and away from each other. Thus, the two or more artificial teeth to be received by the first reception may be arranged within the first reception, while their positions relative to each other within the first reception are still adjustable. These positions within the first reception may be adjusted, until they fit properly a patient's anatomy. The adjusting may, e.g., comprise a moving of the two or more artificial teeth within the first reception towards and/or away from each other within the first reception. This freedom of movement may be provided by the first reception providing a reception volume, which is larger than a combination of basal volumes of the two or more basal sections of the two or more artificial teeth to be received by the first reception. The first reception may, e.g. comprise no barriers hindering a moving of a basal section of an artificial teeth to be received by the first reception within the first reception. A basal section of a single artificial teeth to be received by the first reception may be movable from one distal end to another.

The first reception may, e.g., be an elongated reception extending along an arch. The arch may have the form of a dental to be formed by the artificial teeth to be received by the try-in denture base and/or of a ridge of a patient's intraoral tissue, i.e., gingiva, on which the try-in denture base is to be arranged.

The try-in denture base is configured to receive a plurality of artificial teeth within its one or more receptions. By arranging artificial teeth within theses one or more receptions of the try-in denture base a preliminary denture arrangement with a plurality of artificial teeth may be prepared for placement into a patient's mouth. The resulting preliminary denture may be configured for being placed into a patient's mouth to evaluate aesthetics and/or maxillomandibular relationships of the arrangement. By adjusting the positions of artificial teeth received within the first reception, aesthetics and/or maxillomandibular relationships may be adjusted to properly fit a patient's anatomy.

Such a try-in denture may, e.g., be used to find positions of artificial teeth properly fitting a patient's individual anatomy and/or requirements. Artificial teeth may, e.g., be arranged within the try-in denture base. For example, the artificial teeth may be arranged within receptions of the try-in denture base defining pre-defined positions for the artificial teeth to be received. The try-in denture base may be used to check these pre-defined positions. For example, it may be checked whether an occlusion of the artificial teeth arranged at the pre-defined positions is correct. Further, the try-in denture base may, e.g., be used to check whether the artificial teeth arranged at the pre-defined positions are correctly related to the patient's oral anatomy. Further, the try-in denture base may, e.g., be used to check whether the artificial teeth arranged at the pre-defined positions are correctly related to the patient's face. For example, it may be checked whether the artificial teeth are correctly aligned with a facial middle line, whether upper and lower midlines of an upper and a lower denture part match, whether the positions of the maxillary canines, i.e., teeth 13 and 23 according to the FDI World Dental Federation notation, are correct relative to the patient's face and/or whether a relation of a smile lip line to the positions of the artificial teeth is correct. When checking the smile lip line, it may, e.g. be checked how much gingival tissue above the artificial teeth is visible in a full smile. With the try-in denture base the position of the artificial teeth can be checked clinically, i.e., at chair site within the patient's mouth. Pre-defined teeth positions may be adjusted on the spot, while tying the try-in denture base with the artificial teeth in the patient's mouth.

The positions of the artificial teeth may be adjusted until one or more or all the aforementioned requirements being checked are met. The resulting try-in denture base with the adjusted teeth positions may be used as a template for manufacturing a final denture. The try-in denture base with the adjusted teeth may, e.g., be scanned and a three-dimensional digital model of the try-in denture base with the adjusted teeth positions may be generated using the scan data. The three-dimensional digital model of the try-in denture base with the adjusted teeth positions may, e.g., be used a template for manufacturing the final denture.

The try-in denture base may, e.g., be made from a material having a higher degree of hardness than wax. The try-in denture base may, e.g., be made from plastic. When being made from plastic, the denture base may be easily manufacturable on site, e.g., using a rapid prototyping method like 3D printing or milling. Plastic may ensure a high level of stability of the try-in denture, even in case of higher temperatures, like in summer. At the same time, the continuous open space formed by the first reception may enable a relative movability of the artificial teeth arranged within this reception towards and away from each other. Thus, the try-in denture may be stable and at the same time adjustable. Since the reception volume provided by the first reception is larger than the combination of the basal volumes of the basal sections of the artificial teeth arranged therein, there is a clearance provided within the first reception even with the basal sections of the artificial teeth arranged therein. This clearance provided by the first reception may be used for receiving wax, e.g. melted wax. Arranging the artificial teeth within melted wax distributed within the first reception may provide a sufficient support to hold the artificial teeth in place within the reception. In particular, after the wax is hardened, it may hold the teeth stable in place. But at the same time the wax may enable an adjustment of the positions and/or orientations of the artificial teeth. For this purpose, the wax in the reception may be locally warmed-up, such that a movement of one or more individual artificial teeth or even of all the artificial within the warmed-up wax is enabled. Thus, the position and/or orientation of individual artificial teeth or even of all the artificial arranged within the first reception may easily be adjustable. At the same time the overall stability and form of the try-in denture base may remain unaltered.

A try-in denture base made from a material with a higher degree of hardness than wax may provide a higher stability than a try-in denture made from wax. Compared to a try-in denture with a base made from wax, e.g., a base made from plastic may provide a higher stability. Furthermore, a base made from plastic can be manufactured using rapid prototyping methods. A try-in denture base made from plastic with a first reception as described herein may further enable an adjustment of the positions and/or orientations of the artificial teeth. Such an adjustability cannot be provided by a try-in denture may as a single piece, e.g., a try-in denture made from wax as a single piece, i.e., with base and artificial teeth forming together a single piece.

The first reception may have a volume enabling to move artificial teeth arranged therein up, down, forward, backward, and/or sideways. Furthermore, it may also be possible to rotate artificial teeth arranged therein. The artificial teeth may, e.g., each be rotatable around an axis extending in an occlusal or incisal direction, around an axis extending in a vestibular direction, and/or around an axis extending in a direction perpendicular to the occlusal and vestibular direction, e.g., in an approximal direction. Thus, positions and orientations of the artificial teeth arranged within the first reception may be adjustable. The artificial teeth arranged within the first reception may, e.g., be moved up, down, forward, backward, and/or sideways until they accurately fit the patient's anatomy. In addition, the artificial teeth arranged within the first reception may, e.g., rotated until they accurately fit the patient's anatomy. The positions and/or orientations of the artificial teeth may, e.g., be adjusted in relation to the patient's face, in particular in relation to the geometry of the patient's face. The positions and/or orientations of the artificial teeth may, e.g., be adjusted to correct an occlusion. The try-in denture adjusted this way may, e.g., be scanned in order to provide a three-dimensional digital model of the adjusted try-in denture as template for a final prosthesis, i.e., denture to be manufactured using this template.

For example, the try-in denture base is a try-in denture base of a full try-in denture. A try-in denture base for a full try-in denture is configured for receiving artificial teeth of a full dental arch, e.g., a maxillary or mandibular dental arch. The full try-in denture may be a full try-in denture configured to be arranged on a maxilla or mandible. For example, the try-in denture base is a try-in denture base of a partial try-in denture. A try-in denture base for a partial try-in denture is configured for receiving a plurality of artificial teeth, which does not form a full dental arch. The partial try-in denture may be a partial try-in denture configured to be arranged on a maxilla or mandible.

For example, the first reception provides one or more clearances between neighboring basal sections of the two or more basal sections arranged within the first reception. The clearances enable a relative movement of the respective neighboring basal sections within the first reception towards each other. For example, the first reception provides one or more clearances between basal sections of the two or more basal sections arranged within the first receptions and inner sidewalls of the first reception. The clearances enable a relative lateral movement of the respective basal sections within the first reception along the dental arch. Furthermore, a movement in vestibular direction and/or in oral direction may be enabled.

For example, each of the artificial teeth of a plurality of artificial teeth to be arranged within the one or more receptions of the try-in denture base are assigned to one of the one or more receptions. To the first reception of the one or more receptions more than one artificial tooth is assigned.

For example, the first reception of the try-in denture base is configured for receiving one or more incisors and/or one or more canines. For example, the first reception of the try-in denture base is configured for receiving four incisors. For example, the first reception of the try-in denture base is configured for receiving four incisors and two canines. For example, the try-in denture base comprises a single first reception.

For example, the try-in denture base comprises more than one first reception. The first receptions may each be configured to receive two or more basal sections of two or more artificial teeth of the plurality of artificial teeth. A reception volume provided by each of the first receptions may be larger than a combination of basal volumes of the two or more basal sections of the two or more artificial teeth to be received by the respective first reception. Each first reception may form a continuous open space configured to enable a relative movement of the two or more basal sections of the two or more artificial teeth arranged within the respective first reception towards and away from each other.

For example, the reception volume is at least 10% larger and at most 30% larger than the combination of basal volumes of the two or more basal sections of the two or more artificial teeth to be received by the first reception. For example, the reception volume is at least 15% larger and at most 25% larger than the combination of basal volumes of the two or more basal sections of the two or more artificial teeth to be received by the first reception.

Examples may ensure that the first reception provides a sufficiently large clearance for enabling a moving of the two or more basal sections of the two or more artificial teeth of the plurality of artificial teeth to be received by the first reception within the respective first reception. Thus, an adjusting of positions and/or orientations of the two or more artificial teeth within the first reception may be enabled to adequately fit a patient's anatomy. In particular, a relative movement of the two or more basal sections of the two or more artificial teeth within the first reception towards and away from each other may be enabled. The first reception may enable to move of artificial teeth arranged within the first reception up, down, forward, backward, and/or sideways. Furthermore, it may also be possible to rotate artificial teeth arranged therein. The artificial teeth may, e.g., each be rotatable around an axis extending in an occlusal or incisal direction, around an axis extending in a vestibular direction, and/or around an axis extending in a direction perpendicular to the occlusal and vestibular direction, e.g., in an approximal direction.

For example, the first reception comprises a plurality of first positioning elements configured to position the two or more basal sections of the two or more artificial teeth at pre-defined positions within the first reception. Examples may facilitate an initial arranging of the two or more artificial teeth at pre-defined positions within the first reception by using the first positioning elements. These pre-defined positions may be initial positions, from which an adjusting of positions and/or orientations of the two or more artificial teeth within the first reception is started.

The first positioning elements may be used to position the artificial teeth at the pre-defined positions within the first reception. The first positioning elements may further be configured to support the artificial teeth and/or to hold them in place. Thus, the artificial teeth may, e.g., not or not only be held in place by wax inserted into the first reception, but rather by the first positioning elements.

For example, the first reception comprises a plurality of first positioning elements may further be configured to define orientations of the two or more artificial teeth. Thus, the two or more artificial teeth may be arrangeable in the first reception with pre-defined orientations using the first positioning elements. The artificial teeth may, e.g., each comprise a support reception configured for receiving one of the first positioning elements. When arranging an artificial tooth within the first reception at a position and with an orientation such that a first positioning element fits into the support reception of the respective artificial tooth, the respective teeth may be arranged at the pre-defined position and/or with the pre-defined orientation.

For example, the first positioning elements are arranged at an oral backwall of the first reception. First positioning elements may be configured to support the artificial teeth at their oral sides, i.e., palatial or lingual side. Supporting the artificial teeth at their oral sides may have the beneficial effect that this supporting does not interfere with a vestibular appearance of the artificial teeth. Thus, the positions and/or orientations of the artificial teeth may be assessed and, if necessary, adjusted without being distracted and/or disturbed by the first positioning elements.

For example, the oral sides of the individual artificial teeth may comprise support receptions for receiving end sections of the first positioning elements. For example, the first position elements may be provided in form of pins.

For example, the first positioning elements are provided in form of pins extending from the oral backwall of the first reception in vestibular direction.

These pins may facilitate an arrangement of the artificial teeth in pre-defined positions within the first receptions. In case the position of one of the artificial teeth positioned using one of the pins has to be adjusted, the pin may, e.g., be broken or cut. For example, the oral sides of the individual artificial teeth may comprise support receptions for receiving end sections of the pins. Pins may have the beneficial effect of being flexible, enabling an easy positioning of the artificial teeth within the first reception at the pre-defined positions. Furthermore, if necessary, they may easily be broken or cut to allow for an adjusting of positions and/or orientations of one or more of the artificial teeth arranged within the first reception. At the same time, the pins may provide a sufficient support for the artificial teeth arranged within the first reception, in particular in combination with wax being arranged within the first reception as well.

For example, the first positioning elements comprise pre-determined breaking sections configured to enable the adjusting of the positions of the two or more artificial teeth starting from the pre-defined positions by a breaking of the first positioning elements at the pre-determined breaking sections.

Examples may enable adjusting of the positions and/or orientations of the two or more artificial teeth despite the first positioning elements. The first positioning elements may enable a positing of the artificial teeth at pre-defined positions and/or with pre-defined orientations in the first reception. For an adjusting of the positions and/or orientations of the two or more artificial teeth starting from the pre-defined positions and/or with pre-defined orientations a breaking of the first positioning elements may be required. The breaking of the first positioning elements and thus the adjusting of the one or more artificial teeth may be facilitated by the pre-determined breaking sections of the first positioning elements. These pre-determined breaking sections may facilitate a breaking of the first positioning elements. For example, a diameter of the first positioning elements may be reduced within the pre-determined breaking sections weakening the structural stability of the first positioning elements within the pre-determined breaking sections. For example, the first positioning elements may be pin-shaped with diameters of the pins being reduced within the pre-determined breaking sections of the pins.

For example, the try-in denture base further comprises in addition to the first reception one or more second receptions configured to receive single basal sections of single artificial teeth of the plurality of artificial teeth. The one or more second receptions comprise openings configured to receive the single basal sections with cross-sections matching cross-sections of the single basal sections to be received.

The second receptions are configured for receiving single artificial teeth and to fix the positions of the artificial teeth being received. The openings of the second receptions may have cross-sections matching cross-sections of the single basal sections to be received by the respective second receptions. Thus, a movement of the artificial teeth arranged within the second receptions may be restricted. The artificial teeth may be prevented from being moved in a lateral direction, when arranged within the second receptions.

There may, e.g., be a number of artificial teeth that are not intended to be moved. These may, e.g., be teeth, which do not contribute directly to an appearance of a patient's smile, like premolars or molars. For these artificial teeth, second receptions may be provided by the try-in denture base with openings comprising cross-sections matching cross-sections of artificial teeth, i.e., basal sections of the artificial teeth to be received. Thus, the artificial teeth may fit into the second receptions such that they cannot be moved, e.g., to the left, to the right, to the front, or to the back, when arranged in the respective receptions. All the other artificial teeth may, e.g., be arranged in one or more first receptions, such that artificial teeth arranged within the same first reception can be moved relative to each other within that reception. In order to support a fixing of the position of these artificial teeth in the one or more first receptions, wax may be used and arranged within the respective receptions.

For example, the matching cross-sections of the single basal sections are cross-sections at pre-defined height of gingival margin lines at the single basal sections.

The second receptions may, e.g., be configured for receiving molars and/or premolars.

For example, the try-in denture base comprises a plurality of first receptions configured to receive two or more basal sections of two or more artificial teeth of the plurality of artificial teeth. The first receptions of the plurality of first receptions may each be configured to receive two or more basal sections of two or more artificial teeth of the plurality of artificial teeth. A reception volume provided by each of the first receptions may be larger than a combination of basal volumes of the two or more basal sections of the two or more artificial teeth to be received by the respective first reception. Each first reception may form a continuous open space configured to enable a relative movement of the two or more basal sections of the two or more artificial teeth arranged within the respective first reception towards and away from each other.

For example, the try-in denture base comprises a single first reception configured to receive two or more basal sections of two or more artificial teeth of the plurality of artificial teeth.

For example, the single first reception is configured to receiving all the basal sections of all the artificial teeth of the plurality of artificial teeth. For example, the single first reception is configured to not receive all the basal sections of all the artificial teeth of the plurality of artificial teeth.

For example, the try-in denture base is made from a material with a degree of hardness higher than wax. For example, the try-in denture base is made from plastic. Examples may have the beneficial effect that the try-in denture base may have a higher stability than a base of a try-in denture made from wax. At the same time, due to the first reception and its configuration, an adjusting of artificial teeth arranged within the first reception is enabled.

In another aspect, the invention relates to a try-in denture assembly comprising the try-in denture base of any of the previous examples of a try-in denture base. The try-in denture assembly further comprises the plurality of artificial teeth.

For example, the assembly further comprises a connection structure connecting the artificial teeth of the plurality of artificial teeth with each other. The artificial teeth of the plurality of artificial teeth are held in fixed pre-defined positions relative to each other by the connection structure.

The connecting structure may facilitate an arranging of the artificial teeth within the one or more receptions of the try-in denture base. Using the connection structure, the artificial teeth of the plurality of artificial teeth may be arranged within the one or more receptions of the try-in denture base with fixed pre-defined positions relative to each other. For example, an arranging of the two or more artificial teeth of the plurality of artificial teeth within the first reception may be facilitate. Using the connection structure, the two or more artificial teeth of the plurality of artificial teeth may be arranged within the first reception with fixed pre-defined positions relative to each other.

For example, all the artificial teeth of the plurality of artificial teeth may be connected to each other via the common connection structure, which defines positions of the artificial teeth relative to each other. For example, receptions of one or more artificial teeth may each have a size matching the size of the basal sections of the respective teeth to be received. These one or more artificial teeth may, e.g., be one or two molars of the artificial teeth, in particular two contralateral counterpart molars. These receptions may be used to define a relative position between the plurality of artificial teeth and the try-in denture base at once by arranging the one or more artificial teeth within the receptions with matching sizes. The positions of these one or more artificial teeth may not be intended to be adjusted, while in the receptions for the remaining artificial teeth of the plurality of artificial teeth melted wax may be arranged as described above. The positions of the remaining artificial teeth may be adjusted by disconnecting the artificial teeth to be adjusted from the common connection structure and locally warming up the wax within the reception of the disconnected artificial tooth, enabling a movement of the respective artificial teeth within its reception. For example, all the artificial teeth may be disconnected from the common connection structure, after arranging of the artificial teeth within the one or more receptions of the try-in denture base using the connection structure. The artificial teeth may be disconnected, e.g. by cutting or breaking. The common connection structure may, e.g., comprise pre-determined breaking sections for disconnecting the artificial teeth.

For example, the connection structure comprises a central section and a plurality of ribs. The ribs connect the artificial teeth with the central section. Thus, the artificial teeth of the plurality of artificial teeth may be held in fixed pre-defined positions relative to each other by the respective ribs.

For example, the plurality of artificial teeth and the connection structure form one piece. Examples may provide the plurality of artificial teeth and the connection structure in a configuration facilitating a handling of the artificial teeth. For example, the artificial teeth and the connection structure forming one piece may be made of plastic. Being made of plastic may facilitate a manufacturing of the artificial teeth and the connection structure, e.g., using methods of rapid prototyping like 3D printing or milling.

For example, the try-in denture assembly further comprises one or more second positioning elements and one or more positioning receptions are configured to receive the one or more second positioning elements. The positioning receptions and the second positioning elements are configured to arrange the connection structure in a pre-defined position relative to the denture base.

Example may facilitate a positioning of the connection structure in the pre-defined position relative to the denture base. Since the connection structure defines the positions of the artificial teeth relative to each, i.e., the pre-defined positions, positioning the connection structure in the pre-defined position relative to the denture base may also result in a positioning of the artificial teeth in pre-defined positions relative to the denture base.

For example, the pre-defined position is a position relative to the try-in denture base within two dimensions, e.g., within a plane parallel to a reference within which the try-in denture base extends. For example, the pre-defined position also comprises a pre-defined distance of the connecting structure from the try-in denture base.

For example, the one or more second positioning elements are comprised by the connection structure, while the one or more positioning receptions are comprised by the denture base. For example, the one or more second positioning elements are comprised by the denture base, while the one or more positioning receptions are comprised by the connection structure.

For example, the one or more positioning receptions and the one or more second positioning elements have complementary cross-sections with geometric forms restricting a relative orientation between the connection structure and the dental base, when the one or more second positioning elements are inserted into the one or more positioning receptions.

For example, the geometric forms of the cross-sections may not be rotational symmetric or the rotational symmetry may be a rotational symmetry of order n, i.e., Cₙ. For example, n is equal to or smaller than 10. For example, n is 8, 7, 6, 5, 4, 3, or 2. Geometric forms with no rotational symmetric or a rotational symmetric of low order may facilitate the relative orientation of the connection structure with the artificial teeth relative the try-in denture base, since there is only a small number of possible orientations, for which the one or more second positioning elements fit into the one or more positioning receptions.

In case of a plurality of second positioning elements and positioning receptions, e.g., a distribution of the second positioning elements and positioning receptions, respectively, may not be rotational symmetric or the rotational symmetry may be a rotational symmetry of order n, i.e., Cₙ. For example, n is equal to or smaller than 10. For example, n is 8, 7, 6, 5, 4, 3, or 2. distributions with no rotational symmetric or a rotational symmetric of low order may facilitate the relative orientation of the connection structure with the artificial teeth relative the try-in denture base, since there is only a small number of possible orientations, for which the second positioning elements fit into the positioning receptions.

For example, the artificial teeth of the plurality of teeth are arranged in the one or more receptions of the try-in denture base.

For example, the try-in denture base further comprises wax being arranged in the first reception around the two or more basal sections of the two or more artificial teeth received by the first reception. Wax within the first reception, which is distributed around the two or more basal sections of the two or more artificial teeth received by the first reception may contribute to supporting the artificial teeth at their respective, e.g., pre-defined positions within the first reception. At the same time, wax may allow for an adjusting of the positions of the artificial teeth. The wax may locally be warmed-up around the one or more artificial teeth to be moved increasing its deformability and thus the movability of the one or more artificial teeth to be moved within the first reception, in order to adjust their positions and/or orientations.

For example, the artificial teeth of the plurality of artificial teeth are made from plastic. For example, the connection structure is made from plastic. Being made of plastic may facilitate a manufacturing of the artificial teeth and/or the connection structure, e.g., using methods of rapid prototyping like 3D printing or milling.

For example, a three-dimensional digital model of the denture base may be generated. The generating of the three-dimensional digital model of the denture base may comprise receiving a three-dimensional digital tissue model of a patient's intraoral tissue. This three-dimensional digital tissue model may, e.g., be generated using scan data of the intraoral tissue. The scan data of the intraoral tissue may, e.g., comprise optical scan data. The optical scan data may, e.g., comprise intraoral optical scan data or optical scan data from an optical scan of a classical mold/impression of the intraoral tissue. The optical scan data may, e.g., provide information about the surface structure of the patient's intraoral tissue comprising the gingiva.

Furthermore, data descriptive of relative positions of maxillary and mandibular intraoral tissue may be received. This data may be acquired using a face bow, e.g., a digital face bow. In addition, data may be acquired using a jaw motion tracker tracking patient individual movements und thus a dynamical relation between the patient's maxillary and mandibular intraoral tissue. Optionally average values may be used for the dynamical relation.

The data may also take into account the effect of pressure being applied onto the intraoral tissue, e.g., gingiva and other soft tissues, which may be deformed under pressure. For example, impressions of the soft tissue may be generated under different levels of pressure and digitized, e.g., scanned.

The three-dimensional digital tissue model may be used to generate a three-dimensional digital denture model of the try-in denture. When generating the three-dimensional digital tissue model, e.g., additional information of the patient's mouth may be taken into account, like smile lip line, facial middle line, position of 13/23 canine teeth relative to the face, etc.

The three-dimensional denture model of the try-in denture may, e.g., comprise a three-dimensional digital base model of the try-in denture base as well as a three-dimensional digital teeth model of the artificial teeth of the try-in denture. The three-dimensional teeth model may comprise a plurality of three-dimensional digital tooth models of the individual artificial teeth of the try-in denture. The three-dimensional teeth model may, e.g. further comprise a three-dimensional digital model of a connecting element connecting the artificial teeth, i.e., the three-dimensional digital tooth models.

For providing the three-dimensional digital tooth models of the artificial teeth, e.g., library teeth may be used. For example, scans of natural teeth may be used for providing the three-dimensional digital tooth models of the artificial teeth. For example, the three-dimensional digital tooth models of the artificial teeth may be generated from scratch.

Teeth positions of artificial teeth comprised by the three-dimensional denture model may be digitally adjusted using a virtual articulator. The data descriptive of relative positions of maxillary and mandibular intraoral tissue of the three-dimensional digital tissue model may be used to define relative positions of a maxillary and a mandibular part of the three-dimensional denture model within the virtual articulator. Furthermore, the data may be used for defining movements of the virtual articulator corresponding to actual movements of the patient's jaws. The virtual articulator may, e.g., be used to test an occlusion of the three-dimensional denture model. If necessary, positions, orientations and/or forms of the artificial teeth defined by the three-dimensional denture model may be adjusted to correct the occlusion.

When the three-dimensional denture model has been generated and digitally tested, manufacturing data comprising the resulting three-dimensional digital denture model may be provided. The manufacturing data may define a three-dimensional digital base model of a try-in denture base of the try-in denture as a template for manufacturing the try-in denture base. The manufacturing data may further define one or more three-dimensional digital tooth models of artificial teeth of a plurality of artificial teeth of the try-in denture as one or more templates for manufacturing the artificial teeth.

The manufacturing data may be used to manufacture the try-in denture base and/or one or more artificial teeth, with the three-dimensional digital base model of the try-in denture base providing a template for the manufacturing of the try-in denture base and/or with the one or more three-dimensional digital tooth models of the artificial teeth providing templates for the manufacturing of the artificial teeth. For the manufacturing, e.g., one or more machining device and/or one or more 3D printing devices may be used.

The three-dimensional digital tooth models of the artificial teeth may, e.g., be provided in form of a three-dimensional digital teeth model, which in addition to the three-dimensional digital tooth models may, e.g., comprise a three-dimensional digital model of the connection structure connecting the three-dimensional digital tooth models of the artificial teeth with each other. The three-dimensional digital teeth model with the three-dimensional digital model of the connection structure may provide a template for the manufacturing of the artificial teeth held in fixed pre-defined positions relative to each other by the connection structure.

In another aspect, the invention relates to a computer program product comprising a non-transitory computer readable storage medium. The non-transitory computer readable storage medium comprises manufacturing data embodied therewith defining a three-dimensional digital base model of a try-in denture base as a first template for manufacturing the try-in denture base.

The try-in denture base comprises one or more receptions for receiving basal sections of artificial teeth of a plurality of artificial teeth. A first reception of the one or more receptions is configured to receive two or more basal sections of two or more artificial teeth of the plurality of artificial teeth. A reception volume provided by the first reception is larger than a combination of basal volumes of the two or more basal sections of the two or more artificial teeth to be received by the first reception. The first reception forms a continuous open space configured to enable a relative movement of the two or more basal sections of the two or more artificial teeth within the first reception towards and away from each other.

The manufacturing data provided by the computer program product may, e.g., define a three-dimensional digital base model of any of the aforementioned examples of the try-in denture base as a template for manufacturing the try-in denture base.

For example, the manufacturing data further defines one or more three-dimensional digital tooth models of artificial teeth of the plurality of artificial teeth as one or more second templates for manufacturing the artificial teeth.

The manufacturing data provided by the computer program product may, e.g., further define three-dimensional digital tooth models of any of the aforementioned examples of the artificial teeth of the plurality of artificial teeth as templates for manufacturing the artificial teeth.

The three-dimensional digital tooth models of the artificial teeth may, e.g., be provided in form of a three-dimensional digital teeth model, which in addition to the three-dimensional digital tooth models may, e.g., comprise a three-dimensional digital model of a connection structure connecting the three-dimensional digital tooth models of the artificial teeth with each other. The three-dimensional digital teeth model with the three-dimensional digital model of the connection structure may provide a template for the manufacturing of the artificial teeth held in fixed pre-defined positions relative to each other by the connection structure.

The manufacturing data provided by the computer program product may, e.g., further define a three-dimensional digital model of any of the aforementioned examples of the connection structure as templates for manufacturing the connection structure.

In another aspect, the invention relates to a computer program comprising manufacturing data defining a three-dimensional digital base model of a try-in denture base as a first template for manufacturing the try-in denture base.

The try-in denture base comprises one or more receptions for receiving basal sections of artificial teeth of a plurality of artificial teeth. A first reception of the one or more receptions is configured to receive two or more basal sections of two or more artificial teeth of the plurality of artificial teeth. A reception volume provided by the first reception is larger than a combination of basal volumes of the two or more basal sections of the two or more artificial teeth to be received by the first reception. The first reception forms a continuous open space configured to enable a relative movement of the two or more basal sections of the two or more artificial teeth within the first reception towards and away from each other.

The manufacturing data provided by the computer program may, e.g., define a three-dimensional digital base model of any of the aforementioned examples of the try-in denture base as a template for manufacturing the try-in denture base.

For example, the manufacturing data further defines one or more three-dimensional digital tooth models of artificial teeth of a plurality of artificial teeth as one or more second templates for manufacturing the artificial teeth.

The manufacturing data provided by the computer program may, e.g., further define three-dimensional digital tooth models of any of the artificial teeth of the plurality of artificial teeth as templates for manufacturing the artificial teeth.

The three-dimensional digital tooth models of the artificial teeth may, e.g., be provided in form of a three-dimensional digital teeth model, which in addition to the three-dimensional digital tooth models may, e.g., comprise a three-dimensional digital model of a connection structure connecting the three-dimensional digital tooth models of the artificial teeth with each other. The three-dimensional digital teeth model with the three-dimensional digital model of the connection structure may provide a template for the manufacturing of the artificial teeth held in fixed pre-defined positions relative to each other by the connection structure.

The manufacturing data provided by the computer program product may, e.g., further define a three-dimensional digital model of any of the aforementioned examples of the connection structure as templates for manufacturing the connection structure.

In another aspect, the invention relates to a computer device comprising a processing unit and a memory storing program instructions executable by the processing unit. The memory further stores manufacturing data defining a three-dimensional base digital model of a try-in denture base as a first template for manufacturing the try-in denture base. The try-in denture base comprises one or more receptions for receiving basal sections of artificial teeth of a plurality of artificial teeth. A first reception of the one or more receptions is configured to receive two or more basal sections of two or more artificial teeth of the plurality of artificial teeth. A reception volume provided by the first reception is larger than a combination of basal volumes of the two or more basal sections of the two or more artificial teeth to be received by the first reception. The first reception forms a continuous open space configured to enable a relative movement of the two or more basal sections of the two or more artificial teeth within the first reception towards and away from each other.

Execution of the program instructions by the processing unit causes the computer device to provide the manufacturing data for a manufacturing of the try-in denture base using the three-dimensional digital base model as the first template for the manufacturing.

The manufacturing data provided by the computer device may, e.g., define a three-dimensional digital base model of any of the aforementioned examples of the try-in denture base as a template for manufacturing the try-in denture base.

For example, the manufacturing data further defines one or more three-dimensional digital tooth models of artificial teeth of a plurality of artificial teeth as one or more second templates for manufacturing the artificial teeth. Execution of the program instructions by the processor further causes the computing device to provide the manufacturing data for a manufacturing of the artificial teeth using the one or more three-dimensional digital tooth models as the one or more second templates for the manufacturing.

The manufacturing data provided by the computer program may, e.g., further define three-dimensional digital tooth models of any of the aforementioned examples of the artificial teeth of the plurality of artificial teeth as templates for manufacturing the artificial teeth.

The three-dimensional digital tooth models of the artificial teeth may, e.g., be provided in form of a three-dimensional digital teeth model, which in addition to the three-dimensional digital tooth models may, e.g., comprise a three-dimensional digital model of a connection structure connecting the three-dimensional digital tooth models of the artificial teeth with each other. The three-dimensional digital teeth model with the three-dimensional digital model of the connection structure may provide a template for the manufacturing of the artificial teeth held in fixed pre-defined positions relative to each other by the connection structure.

The manufacturing data provided by the computer program product may, e.g., further define a three-dimensional digital model of any of the aforementioned examples of the connection structure as templates for manufacturing the connection structure.

In another aspect, the invention relates to a manufacturing system comprising the computer device of any of the aforementioned examples of a computer device. The manufacturing system further comprises one or more manufacturing devices configured to manufacture the try-in denture base. Execution of the program instructions by the processor further causes the computer device to control the one or more manufacturing devices to manufacture the try-in denture base using the manufacturing data with the three-dimensional digital base model of the try-in denture base providing the first template for the manufacturing.

The manufacturing system may, e.g., be configured for manufacturing any of the aforementioned examples of the try-in denture base using the three-dimensional digital model of the try-in denture base provided by the manufacturing data as a template for manufacturing the try-in denture base.

For example, the one or more manufacturing devices of the manufacturing system may comprise one or more of the following: a machining device, a 3D printing device.

For example, the one or more manufacturing devices further are configured to manufacture the artificial teeth of the plurality of artificial teeth. Execution of the program instructions by the processor further causes the computing device to control the one or more manufacturing devices to manufacture the artificial teeth using the one or more three-dimensional digital tooth models of the artificial teeth provided by the manufacturing data as the one or more second templates for the manufacturing.

The manufacturing system may, e.g., be configured for manufacturing any of the aforementioned examples of the artificial teeth using the three-dimensional digital models of the artificial teeth provided by the manufacturing data as templates for manufacturing the artificial teeth.

For example, the one or more manufacturing devices further are configured to manufacture the artificial teeth of the plurality of artificial teeth connected with each other by a connecting structure. The artificial teeth of the plurality of artificial teeth are held in fixed pre-defined positions relative to each other by the connection structure.

Execution of the program instructions by the processor further causes the computing device to control the one or more manufacturing devices to manufacture the artificial teeth using a three-dimensional digital teeth model provided by the manufacturing data as a third template for the manufacturing. The three-dimensional digital teeth model comprising the one or more three-dimensional digital tooth models of the artificial teeth as well as a three-dimensional digital model of the connecting structure connecting the three-dimensional digital tooth models with each other.

The manufacturing system may, e.g., be configured for manufacturing any of the aforementioned examples of the connecting structure connecting the artificial teeth with each other using the three-dimensional digital teeth model provided by the manufacturing data as a template for manufacturing the connecting structure connecting the artificial teeth.

The above-described examples and embodiments may be combined freely as long as the combinations are not mutually exclusive.

### BRIEF DESCRIPTION OF THE DRAWINGS

In the following, examples are described in greater detail making reference to the drawings in which:

FIG. 1 shows an exemplary try-in denture base;

FIG. 2 shows an exemplary try-in denture base with artificial teeth;

FIG. 3 shows an exemplary try-in denture base with artificial teeth;

FIG. 4 shows a cross-sectional view of the exemplary try-in denture base of FIG. 3;

FIG. 5 shows an exemplary try-in denture base with artificial teeth;

FIG. 6 shows an exemplary try-in denture base with artificial teeth;

FIG. 7 shows an exemplary connection structure connecting a plurality of artificial mandibular teeth with each other;

FIG. 8 shows an exemplary connection structure connecting a plurality of artificial mandibular teeth with each other;

FIG. 9 shows an exemplary connection structure connecting a plurality of artificial mandibular teeth with each other;

FIG. 10 shows an exemplary connection structure connecting a plurality of artificial maxillary teeth with each other;

FIG. 11 shows an exemplary connection structure connecting a plurality of artificial maxillary teeth with each other;

FIG. 12 shows an exemplary connection structure connecting a plurality of artificial maxillary teeth with each other;

FIG. 13 shows an exemplary maxillary and an exemplary mandibular set of artificial teeth connected with each other via a connection structure;

FIG. 14 shows an exemplary mandibular try-in denture base;

FIG. 15 shows an exemplary maxillary try-in denture base;

FIG. 16 shows an exemplary set of artificial teeth;

FIG. 17 shows an exemplary mandibular try-in denture base with artificial teeth;

FIG. 18 shows an exemplary maxillary try-in denture base with artificial teeth;

FIG. 19 shows an exemplary maxillary and mandibular try-in denture base with artificial teeth;

FIG. 20 shows an exemplary maxillary try-in denture base with a positioning reception;

FIG. 21 shows an exemplary connection structure with a second positioning element;

FIG. 22 shows an exemplary maxillary try-in denture base with a second positioning element;

FIG. 23 shows an exemplary connection structure with a positioning reception;

FIG. 24 shows a flowchart illustrating an exemplary method for manufacturing a try-in denture base;

FIG. 25 shows an exemplary computer device for generating a three-dimensional digital model of a try-in denture base;

FIG. 26 shows an exemplary computer device for generating a three-dimensional digital model of a try-in denture base; and

FIG. 27 shows an exemplary system for manufacturing a try-in denture base.

### DETAILED DESCRIPTION

In the following, similar elements are denoted by the same reference numerals. Elements which have been discussed previously will not necessarily be discussed in later figures if the function is equivalent.

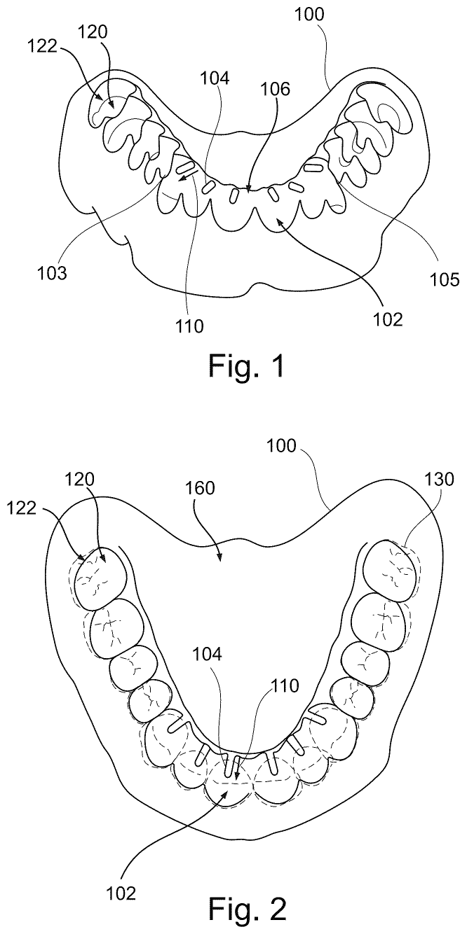

FIG. 1 shows an exemplary try-in denture base 100. The try-in denture base 100 comprises one or more receptions 102, 120 for receiving basal sections of artificial teeth of a plurality of artificial teeth. A first reception 102 of the one or more receptions 102, 120 is configured to receive two or more basal sections of two or more artificial teeth of the plurality of artificial teeth. A volume of the first reception 102, i.e., its reception volume, is larger than a combination of basal volumes of the two or more basal sections of the two or more artificial teeth to be received by the first reception 102. The first reception 102 forms a continuous open space configured to enable a relative movement of the two or more basal sections of the two or more artificial teeth within the first reception 102 towards and away from each other. For example, it may be possible to move a basal section of one of the artificial teeth from one distal end 103 of the first reception 102 to the other distal end 105. Thereby, the basal section of the respective artificial tooth may, e.g., pass a plurality of pre-defined potential positions of the two or more artificial teeth.

The exemplary try-in denture base 100 comprises in addition to the first reception 102 several second receptions 120 configured to receive single basal sections of single artificial teeth of the plurality of artificial teeth. The second receptions 120 comprise openings 122 configured to receive the single basal sections with cross-sections matching cross-sections of the single basal sections to be received. Thus, a position of an artificial tooth arranged in one of the second receptions 120 may be fixed in a lateral direction. For example, the first reception 102 may be configured for receiving artificial incisors and/or canine, while for artificial pre-molars and/or molars may, e.g., individual second receptions 120 are provided.

Furthermore, the first reception 102 of the exemplary try-in denture base 100 may, e.g., comprise a plurality of positioning elements 104, also referred to as “first” positioning elements. These positioning elements 104 are configured to position the basal section of the artificial teeth at pre-defined positions within the first reception 102. The positioning elements 104 may further be configured to support the artificial teeth and/or hold them in place.

In FIG. 1, the positioning elements 104 are, e.g., arranged at an oral backwall 106 of the first reception 102. For example, the positioning elements 104 are provided in form of pins. These pins may extend from the oral backwall 106 of the first reception 102 in vestibular direction 110. The positioning elements 104 may be configured to support the artificial teeth at their palatial side. For example, the palatial sides of the individual artificial teeth may comprise support receptions for receiving end sections of the positioning elements 104 supporting the respective artificial teeth.

For example, the first reception 102 comprises one positioning element 104, i.e., one pin, per artificial tooth to be received by the first perception 102. In case the position of one of the artificial teeth positioned using one of the pins has to be adjusted, the pin may, e.g., be broken or cut. For example, the positioning elements 104 may comprise pre-determined breaking sections configured to enable an adjusting of positions of artificial teeth starting from the pre-defined position, in which they are held by the positioning element 104, by a breaking of the respective positioning elements 104 at the pre-determined breaking section. The pre-determined breaking sections of the positioning elements 104 may, e.g., be sections of the positioning elements 104 with reduced diameters, e.g., reduced diameters of the respective pins.

FIG. 2 shows the exemplary try-in denture base 100 with artificial teeth 130 arranged in the first reception 102 as well as in the second receptions 102 of the try-in denture base 100. The try-in denture base 100 with the artificial teeth 130 form a denture assembly 160. The artificial teeth 130 are indicated by dashed lines. In the example shown, the artificial teeth 130 are the teeth of a full dental arch. The first reception 102 of the example shown in FIG. 2 is configured for receiving artificial incisors and canine, while for artificial pre-molars and molars individual second receptions 120 are provided. Since the first reception 104 forms a continuous open space, the artificial teeth 130 arranged within the first reception 104 can be moved up, down, forward, backward, and/or sideways. Furthermore, it may also be possible to rotate artificial teeth 130 arranged therein. The artificial teeth 130 may, e.g., each be rotatable around an axis extending in an occlusal or incisal direction, around an axis extending in a vestibular direction, and/or around an axis extending in a direction perpendicular to the occlusal and vestibular direction, e.g., in an approximal direction. The first reception 102 may in particular have a width in oral direction, which is larger than a diameter of the basal sections of the artificial teeth 130 such that the artificial teeth 130 can be moved forward and backward, i.e., in vestibular and oral direction. Due to the positioning elements 104, the artificial teeth 130 may be positioned at pre-defined positions, when being inserted into the first reception 102. The positioning elements 104 may further be configured to support the artificial teeth 130 and/or hold them in place within the first reception 102.

The positioning elements 104 may, e.g., be configured as pins. The positioning elements 104 may be configured to support the artificial teeth 130 at their palatial side. For example, the palatial sides of the individual artificial teeth 130 to be arranged in the first reception 102 may comprise support receptions for receiving end sections of the positioning elements 104 supporting the respective artificial teeth.

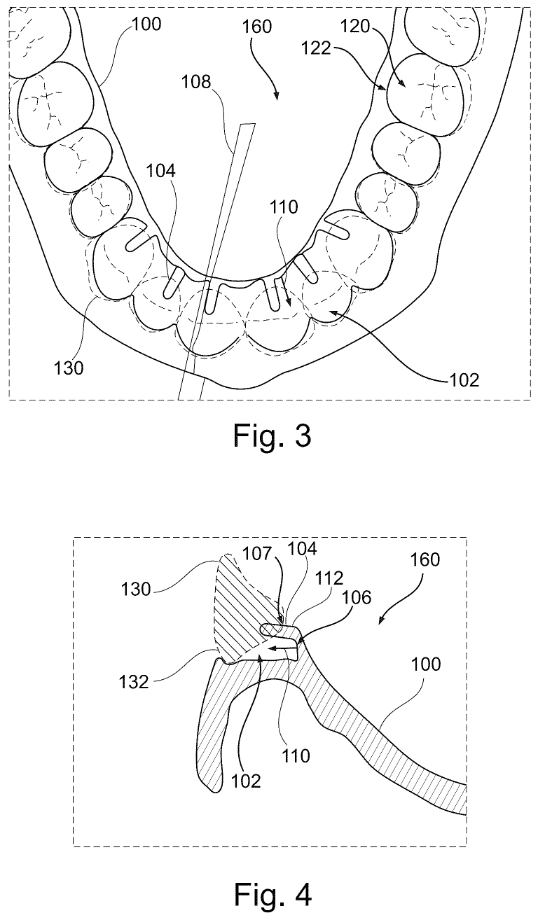

FIG. 3 shows the first reception 102 of FIG. 2 with the artificial teeth 130 arranged therein in more detail. The artificial teeth 130 arranged within the first reception 102 are positioned at pre-defined positions within the first reception 102 by the positioning elements 104. They may further be supported and/or be held in place by the positioning elements 104. Thus, even though a volume of the first reception 102 may be larger than a combination of the basal volumes of the basal sections of the artificial teeth 130 arranged therein and allow for a movement of the artificial teeth 130, the positioning elements 104 may enable an initial fixation of positions of the artificial teeth within the first reception 102. The positioning elements 104 may, e.g., be configured as pins. In case an adjustment of one or more of the artificial teeth 130 arranged within the first reception 102 is required, the positioning elements 104 holding the respective artificial teeth 130 in place may be broken and the artificial teeth 130 can be adjusted. The adjusting may comprise an adjusting of positions and/or orientations of the respective artificial teeth.

The second receptions 120 may comprise no positioning elements 104. Positions of artificial teeth 130 arranged within the second receptions 120 may rather be defined by the second receptions 120 themselves, e.g., by the size of their opening 122.

Furthermore, a cross-sectional plane 108 is shown. The cross-sectional plane 108 extends through the try-in denture base 100, the first reception 102, a positioning element 104 and an artificial tooth arranged within the first reception 102.

FIG. 4 shows a cross-sectional view of the exemplary try-in denture assembly 160 of FIG. 3. The cross-section view shown in FIG. 4 is defined by the cross-sectional plane 108 shown in FIG. 3.

The artificial tooth 130 is arranged with its basal section 132 in the first reception 102 of the try-in denture base 100. The first reception 102 comprise a positioning element 104 for positioning the artificial tooth 130. The positioning element 104 is arranged at an oral backwall 106 of the first reception 102. For example, the positioning element 104 is provided in form of pins. This pin may extend from the oral backwall 106 of the first reception 102 in vestibular direction 110. In the example sown, the artificial tooth 130 comprises at its palatial side a support reception 107 for receiving an end section of the positioning element 104. Thus, the positioning element 104 may position the basal section 132 of the artificial tooth 130 at a pre-defined position within the first reception 102. The positioning element 104 may further support the artificial tooth 130 and hold it in place.

In case the position and/or orientation of the artificial tooth 130 positioned using the positioning element 104 has to be adjusted, the positioning element 104 may, e.g., be broken or cut. For example, the positioning element 104 may comprise a pre-determined breaking section 112. By breaking the positioning element 104, e.g., at the pre-determined breaking section 112, the hold of the positioning element 104 on the artificial tooth 130 may be release. Thus, an adjusting of the position and/or orientation of the artificial tooth 130 starting from the pre-defined position and/or orientation defined by the positioning element 104 may be enabled. The pre-determined breaking section of the positioning element 104 may, e.g., be a section of the positioning element 104 with reduced diameters, e.g., reduced diameters of the respective pin.

In addition, wax may be added to the first reception 102 to fill clearances between the artificial tooth 130 and inner walls of the first reception 102, in particular between the artificial tooth 130 and the oral backwall 106 of the first reception 102. The wax may provide addition support to the artificial tooth 130. In case the position and/or orientation of the artificial tooth 130 has to be adjusted, the wax may be locally warmed-up, in order to enable a movement of the artificial tooth 130 within the warmed wax.

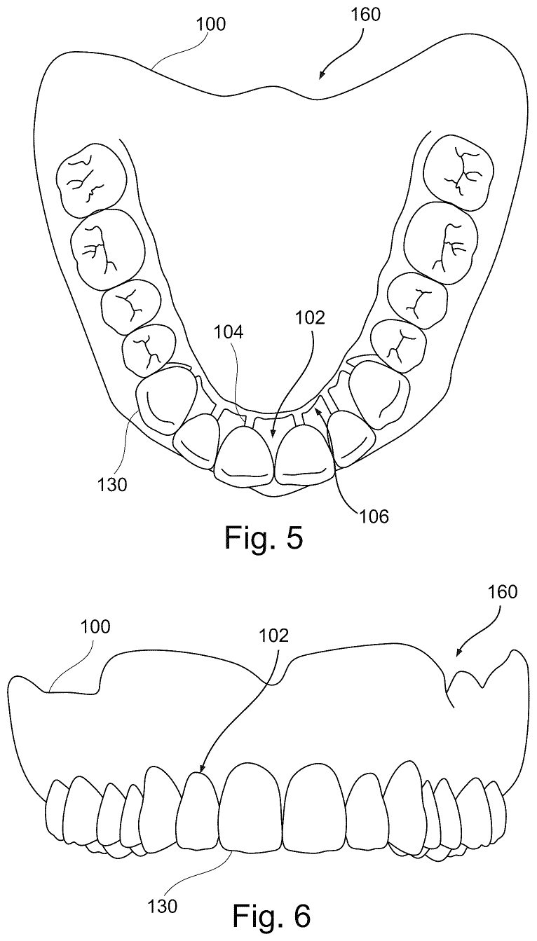

FIG. 5 shows an exemplary try-in denture base 100 with artificial teeth 130 arranged therein. The denture base 100 with artificial teeth 130 form a try-in denture assembly 160. The try-in denture assembly 160 of FIG. 5 corresponds to the try-in denture assembly 160 of FIG. 2. In FIG. 5 the artificial teeth 130 are depicted with solid lines. Regarding the artificial teeth 130 arranged in the first reception 102, the positioning elements 104 holding the respective artificial teeth 130 in place are shown. Furthermore, a clearance between the artificial teeth 130 arranged in the first reception 102 and an oral backwall 106 of the first reception 102 is shown. This clearance may, e.g., be filled up with wax. The wax may provide addition support to the artificial tooth 130. In case the position and/or orientation of the artificial tooth 130 has to be adjusted, the wax may be locally warmed-up, in order to enable a movement of the artificial tooth 130 within the warmed wax.

FIG. 6 shows a front view of a try-in denture assembly 160 comprising a try-in denture base 100 and a plurality of artificial teeth 130. The try-in denture assembly 160 of FIG. 6 may correspond to the try-in denture assemblies 160 of FIGS. 2 and 5. In a front view, the positioning elements 104 may not be visible. Thus, the try-in denture assembly 160 may enable a testing and adjusting of the positions and/or orientations of the artificial teeth 130 without any distraction by the positioning elements 104. In particular, a front appearance of the artificial teeth 130, e.g., when the patient wearing the try-in denture assembly 160 smiles, can be clearly assessed using this setup.

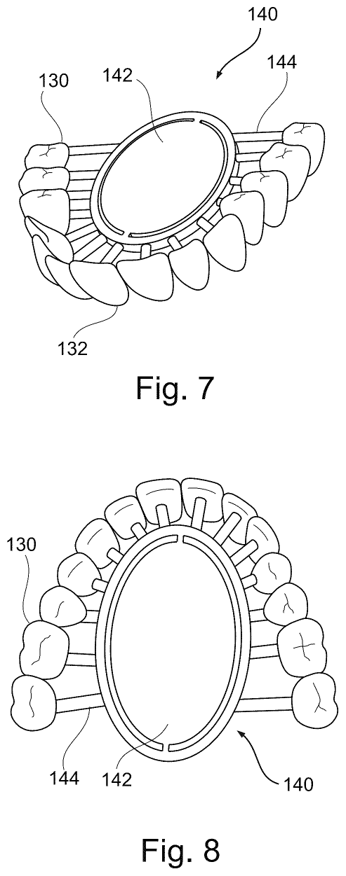

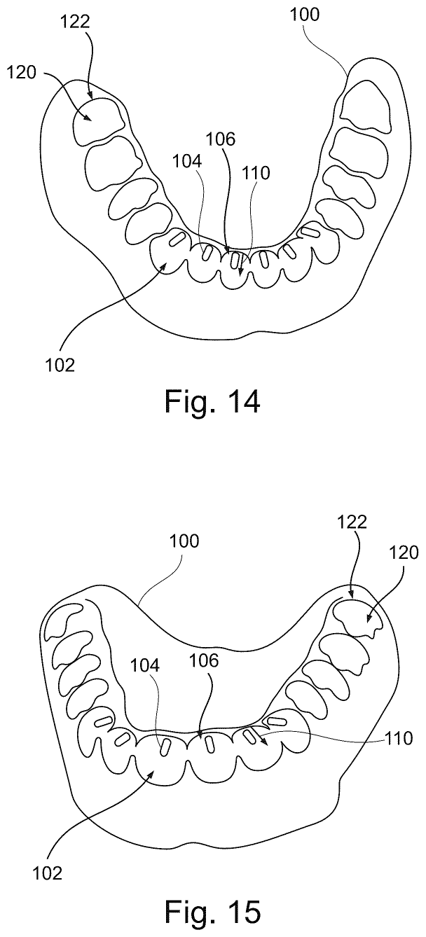

FIG. 7 shows an exemplary connection structure 140 connecting a plurality of artificial teeth 130, e.g., a plurality of mandibular artificial teeth 130, with each other. FIG. 7 is a perspective view onto the connection structure 140 from above, i.e., from an occlusal direction. Thus, the occlusal surfaces and incisal edges of the artificial teeth 130 are shown. The connection structure 140 comprises a central section 142, in the shown example an oval plate, and a plurality of ribs 144. The ribs 144 connect the artificial teeth 130 with the central section 142. The connection structure 140 may comprise a rib 144 for each of the artificial teeth 130. For example, each of the artificial teeth 130 may be connected to the central section 142 by one of the ribs 144. The artificial teeth 130 are held in fixed pre-defined positions relative to each other by the connection structure 140. The artificial teeth 130 held by the connection structure 140 may be artificial teeth 130 of a full dental arch as shown in FIG. 7. Alternatively, the artificial teeth 130 held by the connection structure 140 may be artificial teeth 130 of a partial dental arch or selected artificial teeth 130 of a dental arch. The connection structure 140 may facilitate an arranging of the artificial teeth 130 within a try-in denture base, like the try-in denture base shown in FIG. 14.

For example, the plurality of artificial teeth 130 and the connection structure 140 may form one piece. For example, the one piece formed by the artificial teeth 130 and the connection structure 140 may be made from plastic.

FIG. 8 shows the connection structure 140 of FIG. 7 connecting the plurality of artificial teeth 130, e.g., a plurality of mandibular artificial teeth 130, with each other. FIG. 8 is a view onto the connection structure 140 from above, i.e., from an occlusal direction. Thus, the occlusal surfaces and incisal edges of the artificial teeth 130 are shown.

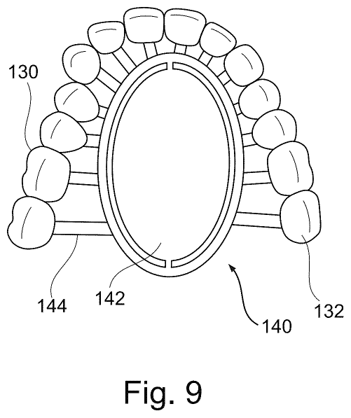

FIG. 9 shows the connection structure 140 of FIGS. 7 and 8 connecting the plurality of artificial teeth 130, e.g., a plurality of mandibular artificial teeth 130, with each other. FIG. 9 is a view onto the connection structure 140 from below, i.e., onto the basal sections 132 of the artificial teeth 130, which are to be received by the one or more receptions of a try-in denture base, like the try-in denture base shown in FIG. 14.

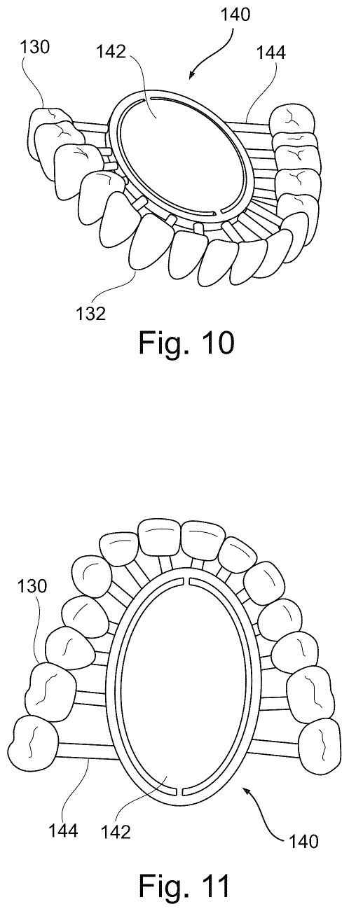

FIG. 10 shows another exemplary connection structure 140 connecting a plurality of artificial teeth 130, e.g., a plurality of maxillary artificial teeth 130, with each other. FIG. 10 is a perspective view onto the connection structure 140 from above, i.e., from an occlusal direction. Thus, the occlusal surfaces and incisal edges of the artificial teeth 130 are shown. The connection structure 140 comprises a central section 142, in the shown example an oval plate, and a plurality of ribs 144. The ribs 144 connect the artificial teeth 130 with the central section 142. The connection structure 140 may comprise a rib 144 for each of the artificial teeth 130. For example, each of the artificial teeth 130 may be connected to the central section 142 by one of the ribs 144. The artificial teeth 130 are held in fixed pre-defined positions relative to each other by the connection structure 140. The artificial teeth 130 held by the connection structure 140 may be artificial teeth 130 of a full dental arch as shown in FIG. 10. Alternatively, the artificial teeth 130 held by the connection structure 140 may be artificial teeth 130 of a partial dental arch or selected artificial teeth 130 of a dental arch. The connection structure 140 may facilitate an arranging of the artificial teeth 130 within a try-in denture base, like the try-in denture base shown in FIG. 15.

For example, the plurality of artificial teeth 130 and the connection structure 140 may form one piece. For example, the one piece formed by the artificial teeth 130 and the connection structure 140 may be made from plastic.

FIG. 11 shows the connection structure 140 of FIG. 10 connecting the plurality of artificial teeth 130, e.g., a plurality of maxillary artificial teeth 130, with each other. FIG. 11 is a view onto the connection structure 140 from above, i.e., from an occlusal direction. Thus, the occlusal surfaces and incisal edges of the artificial teeth 130 are shown.

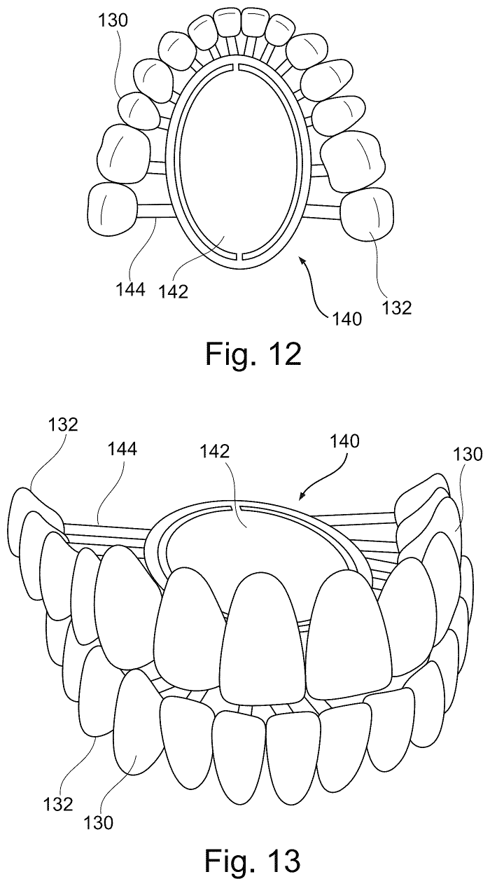

FIG. 12 shows the connection structure 140 of FIGS. 10 and 11 connecting the plurality of artificial teeth 130, e.g., a plurality of maxillary artificial teeth 130, with each other. FIG. 12 is a view onto the connection structure 140 from below, i.e., onto the basal sections 132 of the artificial teeth 130, which are to be received by the one or more receptions of a try-in denture base, like the try-in denture base shown in FIG. 15.

FIG. 13 shows the exemplary connection structure 140 of FIGS. 10 to 12 with a plurality of maxillary artificial teeth 130 arranged on the exemplary connection structure 140 of FIGS. 7 to 9 with a plurality of mandibular artificial teeth 130. The artificial teeth 130 of the maxillary set of artificial teeth 130, i.e., the upper set of artificial teeth 130 in FIG. 13, are held in fixed pre-defined positions relative to each other by the respective connection structure 140, i.e., the upper connection structure 140 in FIG. 13. The artificial teeth 130 of the mandibular set of artificial teeth 130, i.e., the lower set of artificial teeth 130 in FIG. 13, are held in fixed pre-defined positions relative to each other by the respective connection structure 140, i.e., lower upper connection structure 140 in FIG. 13. Using the connection structures 140 for the maxillary and mandibular artificial teeth 130, artificial teeth for a full dentition may be easily arrangeable.

FIG. 14 shows an exemplary mandibular try-in denture base 100. The mandibular try-in denture base 100 may, e.g., be configured for receiving the mandibular artificial teeth of FIGS. 7 to 9. The try-in denture base 100 comprises a first reception 102 as described above, e.g., with regard to FIGS. 1 to 6. The first reception 102 is configured to receive basal sections of a plurality of artificial teeth, e.g. of artificial incisors and canines. A volume of the first reception 102, i.e., its reception volume, is larger than a combination of basal volumes of the basal sections of the artificial teeth to be received by the first reception 102. The first reception 102 forms a continuous open space configured to enable a relative movement of the two or more basal sections of artificial teeth within the first reception 102 towards and away from each other.

The first reception 102 further comprises positioning elements 104, which are, e.g., arranged at an oral backwall 106 of the first reception 102. For example, the positioning elements 104 are provided in form of pins. These pins may extend from the oral backwall 106 of the first reception 102 in vestibular direction 110. The positioning elements 104 may be configured to support the mandibular artificial teeth at their palatial side. For example, the palatial sides of the individual artificial teeth may comprise support receptions for receiving end sections of the positioning elements 104 supporting the respective artificial teeth.

The exemplary mandibular try-in denture base 100 comprises in addition to the first reception 102 several second receptions 120 configured to receive single basal sections of single artificial teeth of the plurality of artificial teeth. The second receptions 120 may comprise openings 122 configured to receive the single basal sections with cross-sections matching cross-sections of the single basal sections to be received. Thus, a position of an artificial tooth arranged in one of the second receptions 120 may be fixed in a lateral direction. For example, the second receptions 120 may be configured for receiving artificial pre-molars and/or molars.

FIG. 15 shows an exemplary maxillary try-in denture base 100. The maxillary try-in denture base 100 may, e.g., be configured for receiving the maxillary artificial teeth of FIGS. 10 to 12. The try-in denture base 100 comprises a first reception 102 as described above, e.g., with regard to FIGS. 1 to 6. The first reception 102 is configured to receive basal sections of a plurality of artificial teeth, e.g. of artificial incisors and canines. A volume of the first reception 102, i.e., its reception volume, is larger than a combination of basal volumes of the basal sections of the artificial teeth to be received by the first reception 102. The first reception 102 forms a continuous open space configured to enable a relative movement of the two or more basal sections of artificial teeth within the first reception 102 towards and away from each other.

The first reception 102 further comprises positioning elements 104, which are, e.g., arranged at an oral backwall 106 of the first reception 102. For example, the positioning elements 104 are provided in form of pins. These pins may extend from the oral backwall 106 of the first reception 102 in vestibular direction 110. The positioning elements 104 may be configured to support the maxillary artificial teeth at their palatial side. For example, the palatial sides of the individual artificial teeth may comprise support receptions for receiving end sections of the positioning elements 104 supporting the respective artificial teeth.

The exemplary maxillary try-in denture base 100 comprises in addition to the first reception 102 several second receptions 120 configured to receive single basal sections of single artificial teeth of the plurality of artificial teeth. The second receptions 120 may comprise openings 122 configured to receive the single basal sections with cross-sections matching cross-sections of the single basal sections to be received. Thus, a position of an artificial tooth arranged in one of the second receptions 120 may be fixed in a lateral direction. For example, the second receptions 120 may be configured for receiving artificial pre-molars and/or molars.

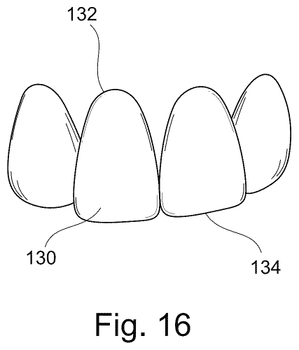

FIG. 16 shows an exemplary set of artificial teeth 130 to be inserted into a first reception of a try-in denture base, e.g., similar to the try-in denture base shown in FIG. 15. The artificial teeth 130 shown are four maxillary incisors. The artificial teeth 130 may, e.g., be part of the artificial teeth shown in FIGS. 10 to 12. The artificial teeth 130 each comprise a basal section, which is to be inserted into the first reception of the try-in denture base. On an opposite end, the artificial teeth 130 may, e.g., comprise incisal edges 134. A volume of the first reception, i.e., its reception volume, may be larger than a combination of basal volumes of the basal sections 132 of the artificial teeth 130. The first reception may form a continuous open space configured to enable a relative movement of the basal sections 132 and thus of the artificial teeth 130 within the first reception, e.g., towards and away from each other. Depending on the configuration of the first reception of the try-in denture base, the set of artificial teeth 130 to be inserted into a first reception may comprise more or less artificial teeth. Considering the first reception of the try-in denture base shown in FIG. 15, the set of artificial teeth 130 in addition may comprise to artificial canines.

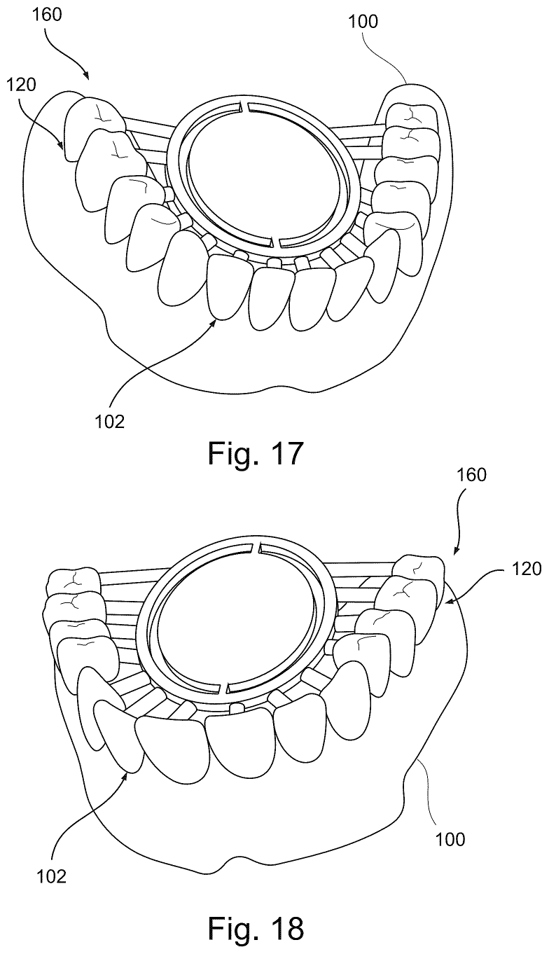

FIG. 17 shows the exemplary mandibular try-in denture base 100 with the mandibular artificial teeth 130 of FIGS. 7 to 9 arranged within the receptions 102, 120 of the mandibular try-in denture base 100. The mandibular try-in denture base 100 with the mandibular artificial teeth 130 forms a mandibular try-in denture assembly 160. The artificial teeth 130 are connected with each other via the connection structure 140 of FIGS. 7 to 9. The connection structure 140 comprises a central section 142, in the shown example an oval plate, and a plurality of ribs 144. The ribs 144 connect the artificial teeth 130 with the central section 142. The connection structure 140 may comprise a rib 144 for each of the artificial teeth 130. For example, each of the artificial teeth 130 may be connected to the central section 142 by one of the ribs 144. The artificial teeth 130 are held in fixed pre-defined positions relative to each other by the connection structure 140. Thus, using the connection structure 140 may enable a user to arrange the artificial teeth 130 in the receptions 102, 120 of the mandibular try-in denture base 100 maintaining the pre-defined positions of the artificial teeth 130 relative to each other as defined by the connection structure 140. After the artificial teeth 130 have been arranged within the receptions 102, 120 of the mandibular try-in denture base 100, the connection structure 140 may be removed. The removing may comprise a breaking and/or cutting of the ribs 144. For example, the ribs 144 may comprise pre-determined breaking sections configured facilitating a detaching of the artificial teeth 130 from the connection structure 140. For example, pre-determined breaking sections may be implemented as sections of the ribs 144 with reduced diameters.

The connection structure 140 with the attached artificial teeth 130 may be provided as one piece, e.g., made from plastic. Thus, a mandibular try-in denture assembly 160 may be provided comprising two pieces, i.e., the mandibular try-in denture base 100 and the connection structure 140 with the attached artificial teeth 130. In particular, a full mandibular try-in denture assembly 160 of a full dental arch may be provided comprising two pieces.

FIG. 18 shows an exemplary maxillary try-in denture base 100 with the maxillary artificial teeth 130 of FIGS. 10 to 12 arranged within the receptions 102, 120 of the maxillary try-in denture base 100. The maxillary try-in denture base 100 with the maxillary artificial teeth 130 forms a maxillary try-in denture assembly 160. The artificial teeth 130 are connected with each other via the connection structure 140 of FIGS. 10 to 12. The connection structure 140 comprises a central section 142, in the shown example an oval plate, and a plurality of ribs 144. The ribs 144 connect the artificial teeth 130 with the central section 142. The connection structure 140 may comprise a rib 144 for each of the artificial teeth 130. For example, each of the artificial teeth 130 may be connected to the central section 142 by one of the ribs 144. The artificial teeth 130 are held in fixed pre-defined positions relative to each other by the connection structure 140. Thus, using the connection structure 140 may enable a user to arrange the artificial teeth 130 in the receptions 102, 120 of the maxillary try-in denture base 100 maintaining the pre-defined positions of the artificial teeth 130 relative to each other as defined by the connection structure 140. After the artificial teeth 130 have been arranged within the receptions 102, 120 of the maxillary try-in denture base 100, the connection structure 140 may be removed. The removing may comprise a breaking and/or cutting of the ribs 144. For example, the ribs 144 may comprise pre-determined breaking sections configured facilitating a detaching of the artificial teeth 130 from the connection structure 140. For example, pre-determined breaking sections may be implemented as sections of the ribs 144 with reduced diameters.

The connection structure 140 with the attached artificial teeth 130 may be provided as one piece, e.g., made from plastic. Thus, a maxillary try-in denture assembly 160 may be provided comprising two pieces, i.e., the maxillary try-in denture base 100 and the connection structure 140 with the attached artificial teeth 130. In particular, a full maxillary try-in denture assembly 160 of a full dental arch may be provided comprising two pieces.

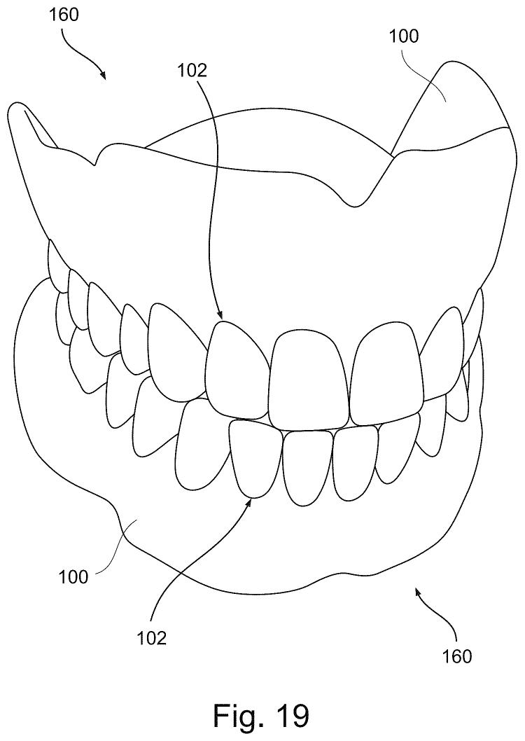

FIG. 19 shows the exemplary maxillary try-in denture assembly 160 of FIG. 18 arranged on the exemplary mandibular try-in denture assembly 160 of FIG. 17. The maxillary try-in denture assembly 160 of FIG. 18 comprises the maxillary try-in denture base 100 with the maxillary artificial teeth 130 connected by the connecting structure as shown in FIG. 18. The mandibular try-in denture assembly 160 of FIG. 17 comprises the mandibular try-in denture base 100 with the mandibular artificial teeth 130 connected by the connecting structure as shown in FIG. 17.

Providing each of the two connection structures 140 with the attached artificial teeth 130 formed as one piece, a full try-in denture for a full dentition comprising the lower mandibular try-in denture assembly 160 and the upper maxillary try-in denture assembly 160 may be provided comprising four pieces, i.e., the mandibular try-in denture base 100, maxillary try-in denture base 100, the connection structure 140 with the attached mandibular artificial teeth 130, and the connection structure 140 with the attached maxillary artificial teeth 130. Thus, an easy and quick assembling of the full try-in denture may be enabled.

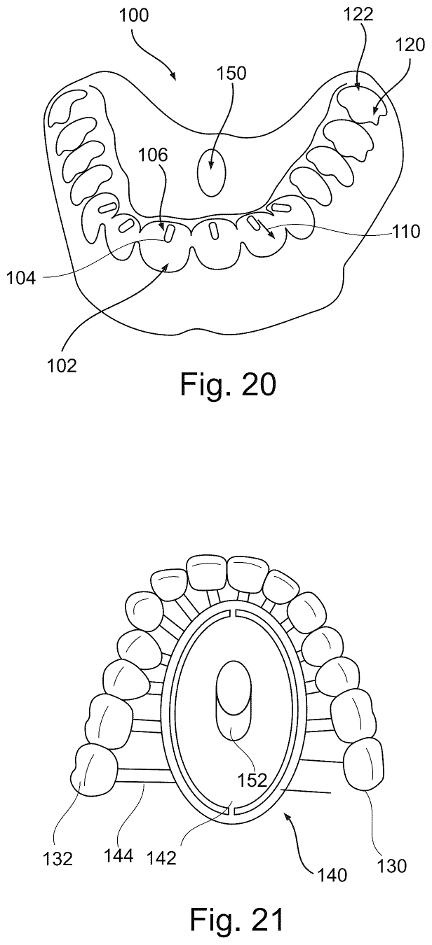

FIG. 20 shows an exemplary try-in denture base 100 with a positioning reception 150. The try-in denture base 100 of FIG. 20 may correspond to the maxillary try-in denture base 100 of FIG. 15. In addition to the features described for FIG. 15, the try-in denture base 100 comprises the positioning reception 150 configured to receive a positioning element of a connection structure, also referred to as a second positioning element. The positioning reception 150 of the try-in denture base 100 and the positioning element of the connection structure are configured to arrange the connection structure in a pre-defined position relative to the denture base 100. The positioning reception 150 and the positioning element may have complementary cross-sections with geometric forms restricting a relative orientation between the connection structure and the dental base 100, when the positioning element is inserted into the positioning reception 150. In the example shown, the positioning reception 150 has an oval cross-section. Thus, there may only be two possible orientations of the connection structure and thus the artificial teeth relative to the dental base 100, which allow the positioning element to be inserted into the positioning reception 150. These two orientations differ by a rotation of 180° around an axis of rotation parallel to a direction of insertion of the positioning element into the positioning reception 150. Of these two orientations, only for one the artificial teeth are aligned with the receptions 102, 120 of the try-in denture base 100. Thus, finding a correct orientation of the connection structure and thus of the artificial teeth relative to the try-in denture base 100 may be facilitated. Alternatively, a plurality of positioning receptions may be comprised by the try-in denture base 100 for receiving a plurality of positioning elements of a connecting structure, i.e. second positioning elements. In that case, the positioning receptions may be distributed asymmetrically or with only a limited rotational symmetry relative to an axis of rotation parallel to the direction of insertion of the positioning elements into the positioning receptions.

FIG. 21 shows an exemplary connection structure 140 with a positioning element 152, also referred to as a second positioning element. The connection structure 140 of FIG. 21 may correspond to the connection structure 140 with the maxillary artificial teeth 130 of FIGS. 10 to 12. In addition to the features described for FIGS. 10 to 12, the connection structure 140 comprises the positioning element 152 configured to be received by the positioning reception 150 of the maxillary try-in denture base 100 of FIG. 20. The positioning element 152 is provided in form of a protrusion, while the positioning reception 150 is form as a recess. The positioning element 152 may, e.g., have a column-or pin-like shape. The positioning element 152 may have a cross-section perpendicular to the direction of insertion, which is complementary to a cross-section of the positioning reception 150 perpendicular to the direction of insertion. The complementary cross-sections may have geometric forms restricting a relative orientation between the connection structure 140 and the dental base 100, when the positioning element 152 is inserted into the positioning reception 150. In the example shown, the positioning element 152 and the positioning reception 150 have oval cross-sections. Thus, there may only be two possible orientations of the connection structure 140 and thus the artificial teeth 130 relative to the dental base 100, which allow the positioning element 152 to be inserted into the positioning reception 150. These two orientations differ by a rotation of 180° around an axis of rotation parallel to the direction of insertion of the positioning element 152 into the positioning reception 150. Of these two orientations, only for one the artificial teeth 130 are aligned with the receptions 102, 120 of the try-in denture base 100. Thus, finding a correct orientation of the connection structure and thus of the artificial teeth 130 relative to the try-in denture base 100 may be facilitated. Alternatively, a plurality of positioning receptions may be comprised by the try-in denture base 100 for receiving a plurality of positioning elements of the connecting structure 140, i.e. second positioning elements. In that case, the positioning receptions may be distributed asymmetrically or with only a limited rotational symmetry relative to an axis of rotation parallel to the direction of insertion of the positioning elements into the positioning receptions.

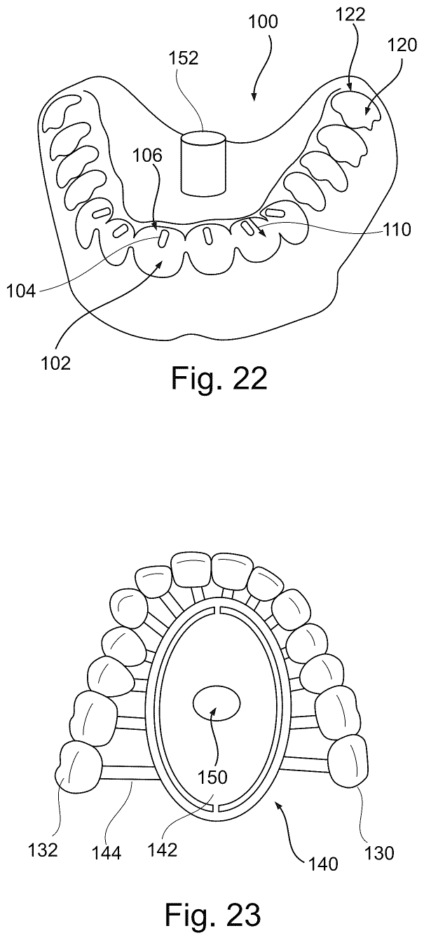

FIG. 22 shows an exemplary try-in denture base 100 with a positioning element 152, also referred to as a second positioning element. The try-in denture base 100 of FIG. 20 may correspond to the maxillary try-in denture base 100 of FIG. 15. In addition to the features described for FIG. 15, the try-in denture base 100 comprises the positioning element 152 configured to be received by a positioning reception of a connection structure. The positioning element 152 is provided in form of a protrusion. The positioning element 152 may, e.g., have a column-or pin-like shape. The positioning element 152 of the try-in denture base 100 and the positioning reception of the connection structure are configured to arrange the connection structure in a pre-defined position relative to the denture base 100. The positioning element 152 and the positioning element may have complementary cross-sections with geometric forms restricting a relative orientation between the connection structure and the dental base 100, when the positioning element 152 is inserted into the positioning reception. In the example shown, the positioning element 152 has an oval cross-section. Thus, there may only be two possible orientations of the connection structure and thus the artificial teeth relative to the dental base 100, which allow the positioning element 152 to be inserted into the positioning reception. These two orientations differ by a rotation of 180° around an axis of rotation parallel to a direction of insertion of the positioning element 152 into the positioning reception. Of these two orientations, only for one of the orientations the artificial teeth are aligned with the receptions 102, 120 of the try-in denture base 100. Thus, finding a correct orientation of the connection structure and thus of the artificial teeth relative to the try-in denture base 100 may be facilitated. Alternatively, a plurality of positioning elements may be comprised by the try-in denture base 100 to be received by a plurality of connecting receptions of a connecting structure. In that case, the positioning elements may be distributed asymmetrically or with only a limited rotational symmetry relative to an axis of rotation parallel to the direction of insertion of the positioning elements into the positioning receptions.

FIG. 23 shows an exemplary connection structure 140 with a positioning reception 150. The connection structure 140 of FIG. 21 may correspond to the connection structure 140 with the maxillary artificial teeth 130 of FIGS. 10 to 12. In addition to the features described for FIGS. 10 to 12, the connection structure 140 comprises the positioning reception 150 configured to receive the positioning element 152 of the maxillary try-in denture base 100 of FIG. 22. The positioning element 152 is provided in form of a protrusion, while the positioning reception 150 is form as a recess. The positioning reception 150 may have a cross-section perpendicular to the direction of insertion, which is complementary to a cross-section of the positioning element 152 perpendicular to the direction of insertion. The complementary cross-sections may have geometric forms restricting a relative orientation between the connection structure 140 and the dental base 100, when the positioning element 152 is inserted into the positioning reception 150. In the example shown, the positioning element 152 and the positioning reception 150 have oval cross-sections. Thus, there may only be two possible orientations of the connection structure 140 and thus the artificial teeth 130 relative to the dental base 100, which allow the positioning element 152 to be inserted into the positioning reception 150. These two orientations differ by a rotation of 180° around an axis of rotation parallel to the direction of insertion of the positioning element 152 into the positioning reception 150. Of these two orientations, only for one of the orientations the artificial teeth 130 are aligned with the receptions 102, 120 of the try-in denture base 100. Thus, finding a correct orientation of the connection structure and thus of the artificial teeth 130 relative to the try-in denture base 100 may be facilitated. Alternatively, a plurality of positioning elements may be comprised by the try-in denture base 100 to be received by a plurality of connecting receptions of a connecting structure. In that case, the positioning elements may be distributed asymmetrically or with only a limited rotational symmetry relative to an axis of rotation parallel to the direction of insertion of the positioning elements into the positioning receptions.

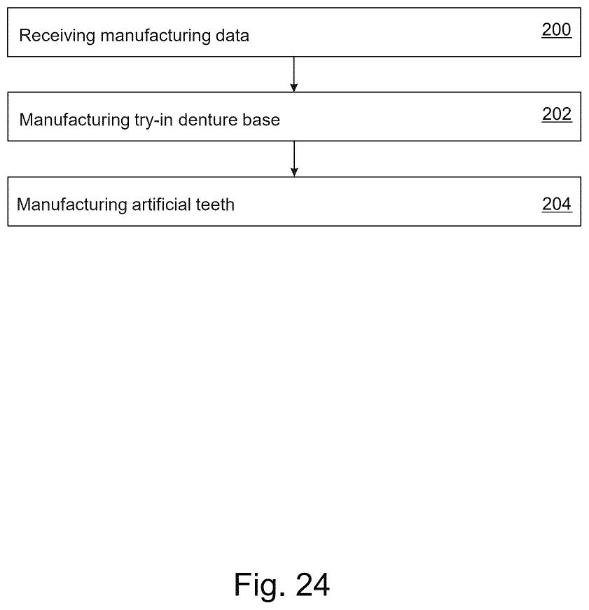

FIG. 24 shows an exemplary method for manufacturing a try-in denture base. In block 200, manufacturing data is received. The manufacturing data may, e.g., define a three-dimensional digital base model of the try-in denture base as a first template for manufacturing the try-in denture base. The try-in denture base comprises one or more receptions for receiving basal sections of artificial teeth of a plurality of artificial teeth. A first reception of the one or more receptions is configured to receive two or more basal sections of two or more artificial teeth of the plurality of artificial teeth. A reception volume provided by the first reception is larger than a combination of basal volumes of the two or more basal sections of the two or more artificial teeth to be received by the first reception. The first reception forms a continuous open space configured to enable a relative movement of the two or more basal sections of the two or more artificial teeth within the first reception towards and away from each other.

Additionally or alternatively, the manufacturing data may, e.g., define one or more three-dimensional digital tooth models of artificial teeth of the plurality of artificial teeth of the try-in denture as one or more second templates for manufacturing the artificial teeth.

The three-dimensional digital tooth models of the artificial teeth may, e.g., be provided in form of a three-dimensional digital teeth model, which in addition to the three-dimensional digital tooth models may, e.g., comprise a three-dimensional digital model of the connection structure connecting the three-dimensional digital tooth models of the artificial teeth with each other. The three-dimensional digital teeth model with the three-dimensional digital model of the connection structure may provide a template for the manufacturing of the artificial teeth held in fixed pre-defined positions relative to each other by the connection structure.

In block 202, the ty-in denture base is manufactured using the manufacturing data with the three-dimensional digital model of the try-in denture base providing the first template for the manufacturing.

In block 204, the artificial teeth are manufactured using the one or more three-dimensional digital tooth models of the artificial teeth provided by the manufacturing data as the one or more second templates for the manufacturing. In case the three-dimensional digital tooth models are provided in form of a three-dimensional digital teeth model, which in addition to the three-dimensional digital tooth models comprises a three-dimensional digital model of the connection structure connecting the three-dimensional digital tooth models of the artificial teeth with each other, the artificial teeth and the connecting structure may be manufactured, e.g., as one piece. The artificial teeth and the connecting structure may be manufactured using the manufacturing data with the three-dimensional digital teeth model providing a template for the manufacturing.

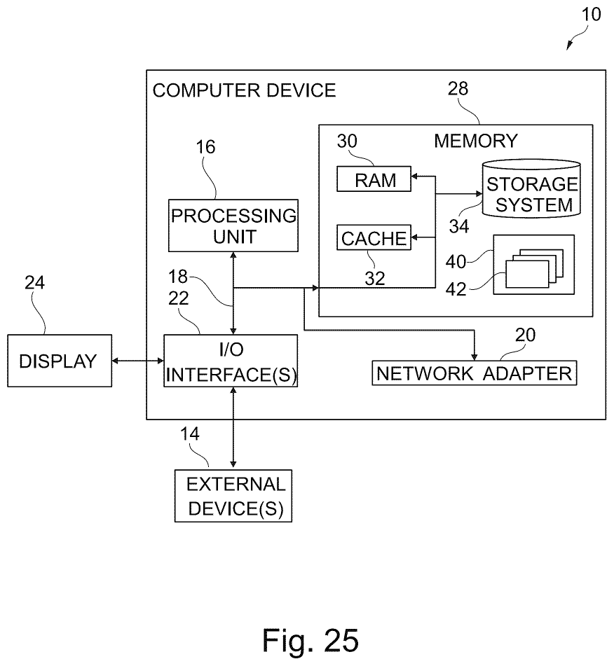

FIG. 25 shows a schematic diagram of an exemplary computer device 10 for providing manufacturing data to manufacture one or more components of a try-in denture assembly. The computer device 10 may be operational with numerous other general-purpose or special-purpose computing system environments or configurations. Computer device 10 may be described in the general context of computer device executable instructions, such as program modules comprising executable program instructions, being executable by the computer device 10. Generally, program modules may include routines, programs, objects, components, logic, data structures, and so on that perform particular tasks or implement particular abstract data types. Computer device 10 may be practiced in distributed computing environments where tasks are performed by remote processing devices that are linked through a communications network. In a distributed computing environment, program modules may be located in both local and remote computer device storage media including memory storage devices.

In FIG. 25, computer device 10 is shown in the form of an exemplary general-purpose computing device. The components of computer device 10 may include, but are not limited to, one or more processors or processing units 16, a system memory 28, and a bus 18 that couples various system components including system memory 28 to processor 16. Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer device 10 may comprise a variety of computer device readable storage media. Such media may be any available storage media accessible by computer device 10, and include both volatile and non-volatile storage media, removable and non-removable storage media.

A system memory 28 may include computer device readable storage media in the form of volatile memory, such as random-access memory (RAM) 30 and/or cache memory 32. Computer device 10 may further include other removable/non-removable, volatile/non-volatile computer device storage media. For example, storage system 34 may be provided for reading from and writing to a non-removable, non-volatile magnetic media also referred to as a hard drive. For example, a magnetic disk drive for reading from and writing to a removable, non-volatile magnetic disk, e.g., a floppy disk, and an optical disk drive for reading from or writing to a removable, non-volatile optical disk such as a CD-ROM, DVD-ROM or other optical storage media may be provided. In such instances, each storage medium may be connected to bus 18 by one or more data media interfaces.

Memory 28 may, e.g., include the manufacturing data. The manufacturing data may comprise a three-dimensional digital base model of a try-in denture base as a first template for manufacturing the try-in denture base. The try-in denture base defined by the three-dimensional digital base model may comprise one or more receptions for receiving basal sections of artificial teeth of a plurality of artificial teeth. A first reception of the one or more receptions is configured to receive two or more basal sections of two or more artificial teeth of the plurality of artificial teeth. A reception volume provided by the first reception is larger than a combination of basal volumes of the two or more basal sections of the two or more artificial teeth to be received by the first reception. The first reception forms a continuous open space configured to enable a relative movement of the two or more basal sections of the two or more artificial teeth within the first reception towards and away from each other.

The manufacturing data may comprise one or more three-dimensional digital tooth models of artificial teeth as one or more second templates for manufacturing the artificial teeth. The three-dimensional digital tooth models of the artificial teeth may, e.g., be provided in form of a three-dimensional digital teeth model, which in addition to the three-dimensional digital tooth models may, e.g., comprise a three-dimensional digital model of a connection structure connecting the three-dimensional digital tooth models of the artificial teeth with each other.

The three-dimensional digital teeth model with the three-dimensional digital model of the connection structure may provide a template for the manufacturing of the artificial teeth held in fixed pre-defined positions relative to each other by the connection structure.

Memory 28 may, e.g., include a three-dimensional digital tissue model of a patient's intraoral tissue. This three-dimensional digital tissue model may, e.g., comprise scan data of the intraoral tissue. The scan data of the intraoral tissue may comprise, e.g., optical scan data. The optical scan data may, e.g., comprise intraoral optical scan data or optical scan data from an optical scan of a classical mold/impression of the intraoral tissue. The optical scan data may, e.g., provide information about the surface structure of the patient's intraoral tissue comprising the gingiva. Furthermore, the memory may comprise data descriptive of relative positions of maxillary and mandibular intraoral tissue. This data may be acquired using a face bow, e.g., a digital face bow. In addition, data may be acquired using a jaw motion tracker tracking patient individual movements und thus a dynamical relation between the patient's maxillary and mandibular intraoral tissue. Optionally average values may be used for the dynamical relation.

The three-dimensional digital tissue model may, e.g., be used for generating a three-dimensional digital try-in denture model. The three-dimensional digital try-in denture model may, e.g., comprise three-dimensional digital base model as well as the three-dimensional digital tooth models and/or the three-dimensional digital teeth model with the model of the connecting structure. When generating the three-dimensional digital tissue model, e.g., additional information of the patient's mouth may be taken into account, like smile lip line, facial middle line, position of 13/23 canine teeth relative to the face, etc.

For providing the three-dimensional digital tooth models of the artificial teeth, e.g., library teeth may be used. For example, scans of natural teeth may be used for providing the three-dimensional digital tooth models of the artificial teeth. For example, the three-dimensional digital tooth models of the artificial teeth may be generated from scratch.

Program 40 may have a set of one or more program modules 42 and by way of example be stored in memory 28. The program modules 42 may comprise an operating system, one or more application programs, other program modules, and/or program data. Each of these program modules 42, i.e., the operating system, the one or more application programs, the other program modules, and/or the program data or some combination thereof, may include an implementation of a networking environment. One or more of the program modules 42 may be configured for executing a method for controlling one or more manufacturing devices to manufacture one or more components of a try-in denture assembly. One or more of the program modules 42 may, e.g., be configured for executing the method of FIG. 24. One or more of the program modules 42 may, e.g., be configured for executing a method for generating a three-dimensional digital try-in denture model as described above.

Computer device 10 may further communicate with one or more external devices 14 such as a keyboard, a pointing device, like a mouse, and a display 24 enabling a user to interact with computer device 10. Such communication can occur via input/output (I/O) interfaces 22. Computer device 10 may further communicate with one or more networks such as a local area network (LAN), a general wide area network (WAN), and/or a public network, like the Internet, via network adapter 20. Network adapter 20 may communicate with other components of computer device 10 via bus 18. It should be understood that although not shown, other hardware and/or software components could be used in conjunction with computer device 10.

The computer device 10 shown in FIG. 25 may, e.g., be configured for controlling a manufacturing of one or more components of a try-in denture assembly using manufacturing data provided for controlling the manufacturing. The manufactured one or more components of a try-in denture assembly may be physical copies of templates defined by the provided manufacturing data.

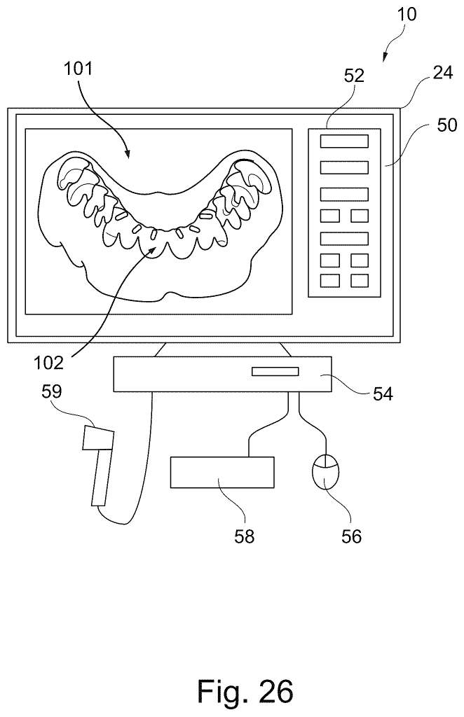

FIG. 26 shows an exemplary computer device 10 for providing manufacturing data to manufacture one or more components of a try-in denture assembly. The computer device 10 may, e.g., be configured as shown in FIG. 25. The computer device 10 may comprise a hardware component 54 comprising one or more processors as well as a memory storing machine-executable program instructions. Execution of the program instructions by the one or more processors may cause the one or more processors to control the computer device 10 to, e.g., provide manufacturing data to manufacture one or more components of a try-in denture assembly and/or to control a manufacturing of the one or more components of the try-in denture assembly using the manufacturing data.

The computer device 10 may further comprise one or more input devices, like a keyboard 58 and a mouse 56, enabling a user to interact with the computer device 10. Furthermore, the computer device 10 may comprise one or more output devices, like a display 24 providing a graphical user interface 50 with control elements 52, e.g., GUI elements, enabling the user to control the planning of the intraoral treatment for the patient. The computer device 10 may further comprise an exemplary scanner 59 configured for scanning a patient's mouth and/or imprints of the patient's intraoral tissue. The scanner 59 may, e.g., comprise an optical scanner configured for scanning, e.g., a patient's oral cavity, an imprint of a patient's oral cavity and/or a positive of a patient's oral cavity generated using an imprint.

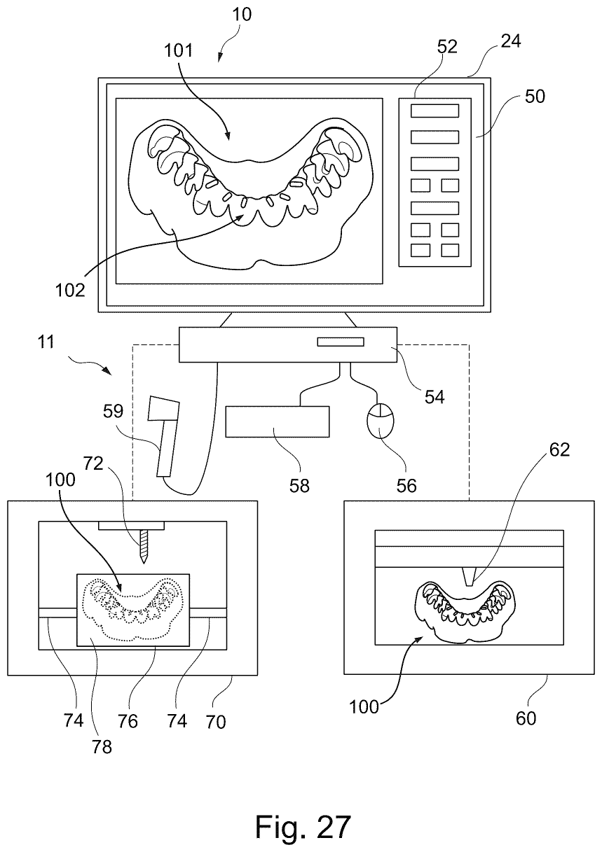

FIG. 27 shows an exemplary manufacturing system 11 for manufacturing one or more components of a try-in denture assembly. The try-in denture assembly may, e.g., comprise a try-in denture base 100. The one or more components of the try-in denture assembly being manufactured may, e.g., comprise the try-in denture base 100 and/or one or more artificial teeth. The artificial teeth may, e.g., be connected with each other via a connecting structure. The one or more components of the try-in denture assembly may, e.g., be manufacture from plastic. The artificial teeth and the connecting structure connecting the artificial teeth with each other may, e.g., be manufactured as one piece.

The manufacturing data provided for controlling the manufacturing of the one or more components of a try-in denture assembly may, e.g., define a three-dimensional digital base model 101 of the try-in denture base 100. The manufacturing data may, e.g., comprise one or more three-dimensional digital tooth models of artificial teeth to be received by the try-in denture base 100. The three-dimensional digital tooth models may, e.g., be provided as part of a three-dimensional digital teeth model, which in addition to the three-dimensional digital tooth models comprises a three-dimensional digital model of a connecting structure connecting the three-dimensional digital tooth models with each other. The three-dimensional digital models of the one or more components of the try-in denture assembly to be manufactured may be provided as templates for the manufacturing. The one or more manufactured components of the try-in denture assembly may be physical copies of the templates defined by the manufacturing data.

The manufacturing system 11 may comprise the computer device 10 of FIG. 26. The computer device 10 may further be configured to control one or more manufacturing devices 60, 70. For controlling the one or more manufacturing devices 60, 70 a processing unit of the computer device 10 may execute program instructions. Execution of the program instructions by the processing unit may cause the computer device 10 to control the one or more manufacturing devices 60, 70 to manufacture the one or more components of the try-in denture assembly, e.g., the try-in denture base 100 using the manufacturing data provided for controlling the manufacturing.

For example, the manufacturing system 11 may comprise a manufacturing device in form of a machining device 70 controlled by the computer device 10. The machining device 70 may be configured to machining a blank 76 using one or more machining tools 72. The blank 76 of raw material 78, may be provided using one or more holding devices 74 and cut into a desired shape and size of the element to be manufactured, e.g., a try-in denture base 100 as a physical copy of a three-dimensional digital base model 101. The machining tool 72 may, e.g., be a milling tool. The raw material 78 may, e.g., be plastic.

For example, the manufacturing system 11 may comprise a manufacturing device in form of a three-dimensional (3D) printing device 60. The 3D printing device 60 may be controlled by the computer device 10 and configured to print an element to be manufactured, e.g., a try-in denture base 100 as a physical copy of a three-dimensional digital base model 101. The 3D printing device 60 may comprise a printing element 62 configured to generate the respective element, like a try-in denture base 100 as a physical copy of a three-dimensional digital base model 101, layer by layer. The printing element 62 may, e.g., comprise a nozzle configured for distributing printing material. The printing material may, e.g., be plastic.

For example, the three-dimensional digital base model 101 may be used as a positive to define a negative of the try-in denture base 100 in form of a negative three-dimensional model. The negative three-dimensional digital model may be used to manufacture, e.g., using machining device 70 or 3D printing device 60, a casting matrix. The casting matrix may be configured for casting the try-in denture base 100 as a physical copy of a three-dimensional digital base model 101 by inserting casting material into the casting matrix and curing the inserted casting material. The casting material may, e.g., be plastic.

The manufacturing devices 60, 70 may further me configured to manufacture one or more artificial teeth to be inserted into the try-in denture base 100. The one or more artificial teeth may, e.g., be manufactured using plastic. The manufacturing devices 60, 70 may further be configured to manufacture a plurality of artificial teeth to be inserted into the try-in denture base 100, which are connected via a connecting structure. The artificial teeth and the connecting structure may, e.g., be manufactured as one piece, e.g., using plastic.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

A single processor or other unit may fulfill the functions of several items recited in the claims. A computer program may be stored/distributed on a suitable medium, such as an optical storage medium or a solid-state medium supplied together with or as part of other hardware, but may also be distributed in other forms, such as via the Internet or other wired or wireless telecommunication Systems.

As will be appreciated by one skilled in the art, aspects of the present invention may be embodied as an apparatus, method, computer program or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer executable code embodied thereon. A computer program comprises the computer executable code or “program instructions”.

Any combination of one or more computer readable medium(s) may be utilized. The computer readable medium may be a computer readable signal medium or a computer readable storage medium. A “computer-readable storage medium” as used herein encompasses any tangible storage medium which may store instructions which are executable by a processor of a computing device. The computer-readable storage medium may be referred to as a computer-readable non-transitory storage medium. The computer-readable storage medium may also be referred to as a tangible computer readable medium. For example, a computer-readable storage medium may also be able to store data which is able to be accessed by the processor of the computing device. Examples of computer-readable storage media include, but are not limited to: a floppy disk, a magnetic hard disk drive, a solid-state hard disk, flash memory, a USB thumb drive, Random Access Memory (RAM), Read Only Memory (ROM), an optical disk, a magneto-optical disk, and the register file of the processor. Examples of optical disks include Compact Disks (CD) and Digital Versatile Disks (DVD), for example CD-ROM, CD-RW, CD-R, DVD-ROM, DVD-RW, or DVD-R disks. A further example of an optical disk may be a Blu-ray disk. The term computer readable-storage medium also refers to various types of recording media capable of being accessed by the computer device via a network or communication link. For example, a data may be retrieved over a modem, over the internet, or over a local area network. Computer executable code embodied on a computer readable medium may be transmitted using any appropriate medium, including but not limited to wireless, wireline, optical fiber cable, RF, etc., or any suitable combination of the foregoing.

A computer readable signal medium may include a propagated data signal with computer executable code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

“Computer memory” or “memory” is an example of a computer-readable storage medium. Computer memory is any memory which is directly accessible to a processor. “Computer storage” or “storage” is a further example of a computer-readable storage medium. Computer storage is any non-volatile computer-readable storage medium. For example, computer storage may also be computer memory or vice versa.

A “processor” as used herein encompasses an electronic component which is able to execute a program or machine executable instruction or computer executable code. References to the computing device comprising “a processor” should be interpreted as possibly containing more than one processor or processing core. The processor may for instance be a multi-core processor. A processor may also refer to a collection of processors within a single computer device or distributed amongst multiple computer devices. The term computing device should also be interpreted to possibly refer to a collection or network of computing devices each comprising a processor or processors. The computer executable code may be executed by multiple processors that may be within the same computing device or which may even be distributed across multiple computing devices.

Computer executable code may comprise machine executable instructions or a program which causes a processor to perform an aspect of the present invention. Computer executable code for carrying out operations for aspects of the present invention may be written in any combination of one or more programming languages, including an object-oriented programming language such as Java,

Smalltalk, C++ or the like and conventional procedural programming languages, such as the “C” programming language or similar programming languages and compiled into machine executable instructions. In some instances, the computer executable code may be in the form of a high-level language or in a pre-compiled form and be used in conjunction with an interpreter which generates the machine executable instructions on the fly.

The computer executable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Generally, the program instructions can be executed on one processor or on several processors. In the case of multiple processors, they can be distributed over several different entities like clients, servers etc. Each processor could execute a portion of the instructions intended for that entity. Thus, when referring to a system or process involving multiple entities, the computer program or program instructions are understood to be adapted to be executed by a processor associated or related to the respective entity.

A “user interface” as used herein is an interface which allows a user or operator to interact with a computer or computer device. A ‘user interface’ may also be referred to as a ‘human interface device.’ A user interface may provide information or data to the operator and/or receive information or data from the operator. A user interface may enable input from an operator to be received by the computer and may provide output to the user from the computer. In other words, the user interface may allow an operator to control or manipulate a computer and the interface may allow the computer to indicate the effects of the operator's control or manipulation. The display of data or information on a display or a graphical user interface is an example of providing information to an operator. The receiving of data through a keyboard, mouse, trackball, touchpad, pointing stick, graphics tablet, joystick, gamepad, webcam, headset, gear sticks, steering wheel, pedals, wired glove, dance pad, remote control, one or more switches, one or more buttons, and accelerometer are all examples of user interface components which enable the receiving of information or data from an operator.

A GUI element is a data object some of which's attributes specify the shape, layout and/or behavior of an area displayed on a graphical user interface, e.g., a screen. A GUI element can be a standard GUI element such as a button, a text box, a tab, an icon, a text field, a pane, a check-box item or item group or the like. A GUI element can likewise be an image, an alphanumeric character or any combination thereof. At least some of the properties of the displayed GUI elements depend on the data value aggregated on the group of data object said GUI element represents.

Aspects of the present invention are described with reference to flowchart illustrations and/or block diagrams of methods, apparatus (systems) and computer program products. It will be understood that each block or a portion of the blocks of the flowchart, illustrations, and/or block diagrams, can be implemented by computer program instructions in form of computer executable code when applicable. It is further understood that, when not mutually exclusive, combinations of blocks in different flowcharts, illustrations, and/or block diagrams may be combined. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

Although the invention has been described in reference to specific embodiments, it should be understood that the invention is not limited to these examples only and that many variations of these embodiments may be readily envisioned by the skilled person after having read the present disclosure. The invention may thus further be described without limitation and by way of example only by the following embodiments. The following embodiments may contain preferred embodiments. Accordingly, the term “feature combination” as used therein may refer to such a “preferred embodiment”.
1. A try-in denture base comprising one or more receptions for receiving basal sections of artificial teeth of a plurality of artificial teeth,
   a first reception of the one or more receptions being configured to receive two or more basal sections of two or more artificial teeth of the plurality of artificial teeth,
   a reception volume provided by the first reception being larger than a combination of basal volumes of the two or more basal sections of the two or more artificial teeth to be received by the first reception,
   the first reception forming a continuous open space configured to enable a relative movement of the two or more basal sections of the two or more artificial teeth within the first reception towards and away from each other.
2. The try-in denture base of feature combination 1, the reception volume being at least 10% larger and at most 30% larger than the combination of basal volumes of the two or more basal sections of the two or more artificial teeth to be received by the first reception.
3. The try-in denture base of any of the preceding feature combinations, the first reception comprising a plurality of first positioning elements configured to position the two or more basal sections of the two or more artificial teeth at pre-defined positions within the first reception.
4. The try-in denture base of feature combination 3, the first positioning elements being arranged at an oral backwall of the first reception.
5. The try-in denture base of feature combination 4, the first positioning elements being provided in form of pins extending from the oral backwall of the first reception in vestibular direction.
6. The try-in denture base of any of feature combinations 3 to 5, the first positioning elements comprising pre-determined breaking sections configured to enable the adjusting of the positions of the two or more artificial teeth starting from the pre-defined positions by a breaking of the first positioning elements at the pre-determined breaking sections.
7. The try-in denture base of any of the previous feature combinations, the try-in denture base further comprising in addition to the first reception one or more second receptions configured to receive single basal sections of single artificial teeth of the plurality of artificial teeth, the one or more second receptions comprising openings configured to receive the single basal sections with cross-sections matching cross-sections of the single basal sections to be received.
8. The try-in denture base of any of the previous feature combinations, the try-in denture base comprising a plurality of first receptions configured to receive two or more basal sections of two or more artificial teeth of the plurality of artificial teeth.
9. The try-in denture base of any of feature combinations 1 to 8, the try-in denture base comprising a single first reception configured to receive two or more basal sections of two or more artificial teeth of the plurality of artificial teeth.
10. The try-in denture base of any of the previous feature combinations, the try-in denture base being made from plastic.
11. A try-in denture assembly comprising the try-in denture base of any of the previous feature combinations, the try-in denture assembly further comprising the plurality of artificial teeth.
12. The try-in denture assembly of feature combination 11, the assembly further comprising a connection structure connecting the artificial teeth of the plurality of artificial teeth with each other, the artificial teeth of the plurality of artificial teeth being held in fixed pre-defined positions relative to each other by the connection structure.
13. The try-in denture assembly of feature combination 12, the connection structure comprising a central section and a plurality of ribs, the ribs connecting the artificial teeth with the central section.
14. The try-in denture assembly of any of feature combinations 12 to 13, the plurality of artificial teeth and the connection structure forming one piece.
15. The try-in denture assembly of any of feature combinations 12 to 14, the try-in denture assembly further comprising one or more second positioning elements and one or more positioning receptions being configured to receive the one or more second positioning elements, the positioning receptions and the second positioning elements being configured to arrange the connection structure in a pre-defined position relative to the denture base.
16. The try-in denture assembly of feature combination 15, the one or more second positioning elements being comprised by the connection structure, while the one or more positioning receptions being comprised by the denture base, or the one or more second positioning elements being comprised by the denture base, while the one or more positioning receptions being comprised by the connection structure.
17. The try-in denture assembly of any of feature combinations 11 to 16, the artificial teeth of the plurality of teeth being arranged in the one or more receptions of the try-in denture base.
18. The try-in denture assembly of feature combination 17, the try-in denture base further comprising wax being arranged in the first reception around the two or more basal sections of the two or more artificial teeth received by the first reception.
19. The try-in denture assembly of any of feature combinations 11 to 18, the artificial teeth of the plurality of artificial teeth being made from plastic.
20. A computer program product comprising a non-transitory computer readable storage medium comprising manufacturing data embodied therewith defining a three-dimensional digital base model of a try-in denture base as a first template for manufacturing the try-in denture base,
   the try-in denture base comprising one or more receptions for receiving basal sections of artificial teeth of a plurality of artificial teeth,
   a first reception of the one or more receptions being configured to receive two or more basal sections of two or more artificial teeth of the plurality of artificial teeth,
   a reception volume provided by the first reception being larger than a combination of basal volumes of the two or more basal sections of the two or more artificial teeth to be received by the first reception,
   the first reception forming a continuous open space configured to enable a relative movement of the two or more basal sections of the two or more artificial teeth within the first reception towards and away from each other.
21. The computer program product of feature combination 20, the manufacturing data further defining one or more three-dimensional digital tooth models of artificial teeth of a plurality of artificial teeth as one or more second templates for manufacturing the artificial teeth.
22. A computer device comprising a processor and a memory storing program instructions executable by the processor, the memory further storing manufacturing data defining a three-dimensional digital base model of a try-in denture base as a first template for manufacturing the try-in denture base,
   the try-in denture base comprising one or more receptions for receiving basal sections of artificial teeth of a plurality of artificial teeth,
   a first reception of the one or more receptions being configured to receive two or more basal sections of two or more artificial teeth of the plurality of artificial teeth,
   a reception volume provided by the first reception being larger than a combination of basal volumes of the two or more basal sections of the two or more artificial teeth to be received by the first reception,
   the first reception forming a continuous open space configured to enable a relative movement of the two or more basal sections of the two or more artificial teeth within the first reception towards and away from each other,
   execution of the program instructions by the processor causing the computer device to provide the manufacturing data for a manufacturing of the try-in in denture base using the three-dimensional digital base model of the try-in denture base as the first template for the manufacturing.
23. The computing device of feature combination 22, the manufacturing data further defining one or more three-dimensional digital tooth models of artificial teeth of a plurality of artificial teeth as one or more second templates for manufacturing the artificial teeth,
   execution of the program instructions by the processor further causing the computing device to provide the manufacturing data for a manufacturing of the artificial teeth using the one or more three-dimensional digital tooth models of the artificial teeth as the one or more second templates for the manufacturing.
24. A manufacturing system comprising the computer device of any of feature combinations 22 to 23, the manufacturing system further comprising one or more manufacturing devices configured to manufacture the try-in denture base,
   execution of the program instructions by the processor further causing the computer device to control the one or more manufacturing devices to manufacture the try-in denture base using the manufacturing data with the three-dimensional digital base model of the try-in denture base providing the first template for the manufacturing.
25. The manufacturing system of feature combination 24, the one or more manufacturing devices further being configured to manufacture the artificial teeth of the plurality of artificial teeth,
   execution of the program instructions by the processor further causing the computing device to control the one or more manufacturing devices to manufacture the artificial teeth using the one or more three-dimensional digital tooth models of the artificial teeth provided by the manufacturing data as the one or more second templates for the manufacturing.

### REFERENCE SIGNS LIST

10 computer device
11 manufacturing system
14 external device
16 processing unit
18 bus
20 network adapter
22 I/O interface
24 display
28 memory
30 RAM
32 cache
34 storage system
40 program
42 program module
50 user interface
52 control elements
54 hardware device
56 keyboard
58 mouse
59 scanner
60 3D printing device
62 printing element
70 machining device
72 machining tool
74 holding device
76 blank
104 first positioning element
105 distal end
106 oral backwall
107 support reception
108 cross-sectional plane
110 vestibular direction
112 pre-determined breaking section
114 pre-defined position
120 second reception
122 opening
130 artificial tooth
132 basal section
134 incisal edge
140 connection structure
142 central section
144 rib
150 positioning reception
152 second positioning element
160 try-in denture assembly

1. A try-in denture base comprising one or more receptions for receiving basal sections of artificial teeth of a plurality of artificial teeth,
a first reception of the one or more receptions being configured to receive two or more basal sections of two or more artificial teeth of the plurality of artificial teeth,
a reception volume provided by the first reception being larger than a combination of basal volumes of the two or more basal sections of the two or more artificial teeth to be received by the first reception,
the first reception forming a continuous open space configured to enable a relative movement of the two or more basal sections of the two or more artificial teeth within the first reception towards and away from each other.

2. The try-in denture base of claim 1, the reception volume being at least 10% larger and at most 30% larger than the combination of basal volumes of the two or more basal sections of the two or more artificial teeth to be received by the first reception.

3. The try-in denture base of claim 1, the first reception comprising a plurality of first positioning elements configured to position the two or more basal sections of the two or more artificial teeth at pre-defined positions within the first reception.

4. The try-in denture base of claim 3, the first positioning elements being arranged at an oral backwall of the first reception.

5. The try-in denture base of claim 4, the first positioning elements being provided in form of pins extending from the oral backwall of the first reception in vestibular direction.

6. The try-in denture base of claim 3, the first positioning elements comprising pre-determined breaking sections configured to enable the adjusting of the positions of the two or more artificial teeth starting from the pre-defined positions by a breaking of the first positioning elements at the pre-determined breaking sections.

7. The try-in denture base of claim 1, the try-in denture base further comprising in addition to the first reception one or more second receptions configured to receive single basal sections of single artificial teeth of the plurality of artificial teeth, the one or more second receptions comprising openings configured to receive the single basal sections with cross-sections matching cross-sections of the single basal sections to be received.

8. The try-in denture base of claim 1, the try-in denture base comprising a plurality of first receptions configured to receive two or more basal sections of two or more artificial teeth of the plurality of artificial teeth.

9. The try-in denture base of claim 1, the try-in denture base comprising a single first reception configured to receive two or more basal sections of two or more artificial teeth of the plurality of artificial teeth.

10. The try-in denture base of claim 1, the try-in denture base being made from plastic.

11. A try-in denture assembly comprising the try-in denture base of claim 1, the try-in denture assembly further comprising the plurality of artificial teeth.

12. The try-in denture assembly of claim 11, the assembly further comprising a connection structure connecting the artificial teeth of the plurality of artificial teeth with each other, the artificial teeth of the plurality of artificial teeth being held in fixed pre-defined positions relative to each other by the connection structure.

13. The try-in denture assembly of claim 12, the connection structure comprising a central section and a plurality of ribs, the ribs connecting the artificial teeth with the central section.

14. The try-in denture assembly of claim 12, the plurality of artificial teeth and the connection structure forming one piece.

15. The try-in denture assembly of claim 12, the try-in denture assembly further comprising one or more second positioning elements and one or more positioning receptions being configured to receive the one or more second positioning elements, the positioning receptions and the second positioning elements being configured to arrange the connection structure in a pre-defined position relative to the denture base.

16. The try-in denture assembly of claim 15, the one or more second positioning elements being comprised by the connection structure, while the one or more positioning receptions being comprised by the denture base, or
the one or more second positioning elements being comprised by the denture base, while the one or more positioning receptions being comprised by the connection structure.

17. The try-in denture assembly of claim 11, the artificial teeth of the plurality of teeth being arranged in the one or more receptions of the try-in denture base.

18. The try-in denture assembly of claim 17, the try-in denture base further comprising wax being arranged in the first reception around the two or more basal sections of the two or more artificial teeth received by the first reception.

19. A computer program product comprising a non-transitory computer readable storage medium comprising manufacturing data embodied therewith defining a three-dimensional digital base model of a try-in denture base as a first template for manufacturing the try-in denture base,
the try-in denture base comprising one or more receptions for receiving basal sections of artificial teeth of a plurality of artificial teeth,
a first reception of the one or more receptions being configured to receive two or more basal sections of two or more artificial teeth of the plurality of artificial teeth,
a reception volume provided by the first reception being larger than a combination of basal volumes of the two or more basal sections of the two or more artificial teeth to be received by the first reception,
the first reception forming a continuous open space configured to enable a relative movement of the two or more basal sections of the two or more artificial teeth within the first reception towards and away from each other.

20. A computer device comprising a processor and a memory storing program instructions executable by the processor, the memory further storing manufacturing data defining a three-dimensional digital base model of a try-in denture base as a first template for manufacturing the try-in denture base,
the try-in denture base comprising one or more receptions for receiving basal sections of artificial teeth of a plurality of artificial teeth,
a first reception of the one or more receptions being configured to receive two or more basal sections of two or more artificial teeth of the plurality of artificial teeth,
a reception volume provided by the first reception being larger than a combination of basal volumes of the two or more basal sections of the two or more artificial teeth to be received by the first reception,
the first reception forming a continuous open space configured to enable a relative movement of the two or more basal sections of the two or more artificial teeth within the first reception towards and away from each other,
execution of the program instructions by the processor causing the computer device to provide the manufacturing data for a manufacturing of the try-in denture base using the three-dimensional digital base model of the try-in denture base as the first template for the manufacturing.
